(19) United States
(12) Patent Application Publication
(10) Pub. No.: US 2016/0032836 A1
(43) Pub. Date: Feb. 4, 2016

(54) FILTRATION SYSTEM FOR A GAS TURBINE AIR INTAKE AND METHODS

(71) Applicants: Andrew James HAWKINSON, (US); Eli Payton ROSS, (US); Jon Jerrold HAAG, (US); Thomas D. RAETHER, (US)

(72) Inventors: Andrew James HAWKINSON, Eden Prairie, MN (US); Eli Payton ROSS, Morristown, MN (US); Jon Jerrold HAAG, Vadnais Heights, MN (US); Thomas D. RAETHER, St. Louis Park, MN (US)

(21) Appl. No.: 14/772,330

(22) PCT Filed: Mar. 6, 2014
(86) PCT No.: PCT/US14/21396

§ 371 Date: Sep. 2, 2015

Related U.S. Application Data
(60) Provisional application No. 61/774,676, filed on Mar. 8, 2013.
(60) Provisional application No. 61/942,844, filed on Feb. 21, 2014.

(51) Int. Cl. F02C 7/052

(52) U.S. Cl. CPC F02C 7/052

(57) ABSTRACT

A gas turbine air filter system includes a housing having an interior, an inlet arrangement, and an outlet hood having an outlet arrangement. The inlet arrangement defines an inlet flow face for taking in unfiltered air. The outlet arrangement defines an outlet flow face for exiting filtered air. The inlet flow face and the outlet flow face are angled relative to each other. The angle can range between 45-135° relative to each other. The system includes at least first and second stages of filter element arrangements held within the interior of the housing. The first and second stages of filter element arrangements are operably sealed within the housing such that air flowing through the inlet arrangement must pass through the first and second stages of filter element arrangements before exiting through the outlet arrangement. The outlet hood is free of the first and second stages of filter element arrangements.

This application is being filed on 6 Mar. 2014, as a PCT International patent application and claims priority to U.S. Provisional Application Ser. No. 61/774,676, filed Mar. 8, 2013, and U.S. Provisional Application Ser. No. 61/942,844, filed Feb. 21, 2014, the subject matter of which are incorporated by reference in their entirety.

### TECHNICAL FIELD

This disclosure concerns filters and methods for use in filtering air for a gas turbine air intake.

### BACKGROUND

Inlet air filtration systems are generally employed for use with gas turbines and operate by removing salt, dust, corrosives, and water from inlet air to prevent their entry into the gas turbine and corrode and/or damage the gas turbine components. Gas turbine damage and corrosion can lead to operational inefficiencies or failures and financial loss.

It is desirable to have systems that can be easily retrofitted into existing systems. Further, it is desirable to have systems that can be easily adjusted to accommodate more or less stages of filtration, depending on the environment.

### SUMMARY

A filtration system for a gas turbine air intake is provided.

In example aspects, the system includes a housing having an interior, an inlet arrangement, and an outlet hood having an outlet arrangement. The inlet arrangement defines an inlet flow face for taking in unfiltered air. The outlet arrangement defines an outlet flow face for exiting filtered air. The inlet flow face and the outlet flow face are angled relative to each other. The angle can range between 45-135° relative to each other. The system includes at least first and second stages of filter element arrangements held within the interior of the housing. The first and second stages of filter element arrangements are operably sealed within the housing such that air flowing through the inlet arrangement must pass through the first and second stages of filter element arrangements before exiting through the outlet arrangement. The outlet hood is free of the first and second stages of filter element arrangements.

The at least first and second stages of filter element arrangements may include at least a third stage of filter element arrangement operably sealed within the housing.

In some aspects, the at least first and second stages of filter element arrangements include a plurality of further stages of filter element arrangements operably sealed within the housing, each of the stages being either upstream or downstream of the other stages in the housing.

In some embodiments, one of the at least first and second stages of filter element arrangement includes a pre-filter arrangement at or adjacent to the inlet arrangement. The pre-filter arrangement can be the most upstream stage of filter element arrangement.

The first stage of filter element arrangements may include a plurality of elements operably held by a first tubesheet in the interior of the housing.

The second stage of filter element arrangements can include a plurality of elements operably held by a second tubesheet in the interior of the housing. The second tubesheet is downstream of the first tubesheet.

In one aspect, the first tubesheet is +/−30° of being parallel to the inlet flow face. The second tubesheet is spaced from the first tubesheet and is +/−30° of being parallel to the first tubesheet.

In example implementations, the second tubesheet can include a series of steps.

In one aspect, the second stage filter element arrangement is oriented vertically above the first stage filter element arrangement, and the second stage filter element arrangement has a horizontal footprint that is smaller than a horizontal footprint of the first stage filter element arrangement.

The housing may include a base structure holding the first stage filter element arrangement spaced vertically above a base surface. The inlet flow face is between the base surface and the first stage filter element arrangement.

In one aspect, the inlet flow face and the outlet flow face are angled 70-110° relative to each other.

In some systems, a pulse jet system is oriented within the housing interior and is disposed to periodically send a blast of fluid to the first stage filter element arrangement.

In systems that include a pulse jet system, there can be a tubesheet arranged in the housing interior dividing the interior between an unfiltered air volume and a filtered air volume. The tubesheet will have a plurality of apertures, and the tubesheet will have a dirty air side in the unfiltered air volume and an opposite clean air side in the clean air volume. A plurality of pulse collectors can be mounted in communication with the apertures in the tubesheet in the unfiltered air volume. The first stage filter element arrangement can be mounted in communication with the pulse collectors in the unfiltered air volume, the pulse collectors being axially between the first stage filter elements and the tubesheet.

The pulse collectors can be Venturi members, in some systems.

The pulse collectors can be non-porous, non-perforated tubes in some systems.

In some examples, the clean air side of the tubesheet is pulse collector free.

The pulse jet system may include a blowpipe having pipe extensions to direct the blast of fluid to the first stage filter element arrangement.

The pulse jet system may include a blowpipe with holes that is pipe extension free to direct the blast of fluid to the first stage filter element arrangement.

In some examples, the system is a static system and is free of a pulse jet cleaning system.

The second stage filter element arrangement can include a plurality of filter elements having non-cylindrical and non-panel shaped media packs.

The second stage filter element arrangement can include a plurality of filter elements having pleated media and having a wave-shaped cross-section.

The first stage filter arrangement can include a plurality of cylindrical elements of pleated media.

In another aspect, a method of filtering air for a gas turbine system is provided. The method includes directing air to be filtered in through an inlet flow face of an inlet arrangement of a housing having an interior. The method may include directing the air through at least first and second stages of filter element arrangements held within the interior of the housing. The first and second stages of filter element arrangements are operably sealed within the housing such that air flowing through the inlet arrangement must pass through the first and second stages of filter element arrangements. The method may include directing the air through an outlet hood having an outlet arrangement defining an outlet flow face. The outlet flow face can be angled 45-135° relative to the inlet flow face. The outlet hood can be free of the first and second stages of filter element arrangements.

In one aspect, the step of directing the air through at least first and second stages of filter element arrangements includes directing the air through a plurality of further stages of filter element arrangements operably sealed within the housing, each of the stages being one of upstream or downstream of the other stages in the housing.

In some example methods, there may be a step of periodically directing a jet pulse of fluid from a downstream side to an upstream side of the first stage filter element arrangements.

The step of periodically directing a jet pulse of fluid can include directing the jet pulse of fluid through a plurality of pulse collectors positioned in an unfiltered air volume of the housing and then directing the jet pulse to the first stage filter element arrangements.

In some methods, the step of directing the jet pulse of fluid through a plurality of pulse collectors can include directing the jet pulse of fluid through a filtered air volume of the housing that is free of pulse collectors.

Some methods may include the step of periodically directing a jet pulse of fluid includes directing the jet pulse of fluid through a plurality of pipe extensions protruding from a blowpipe.

In another aspect, a gas turbine air intake system is provided including a housing having an inlet arrangement, an outlet hood for exhausting filtered air, and an internal volume; a tubesheet arranged in the housing volume, the tubesheet dividing the volume between an unfiltered air volume and a filtered air volume; the tubesheet having a plurality of apertures; a plurality of pulse collectors mounted in communication with the apertures in the tubesheet in the unfiltered air volume; and a plurality of filter elements mounted in communication with the pulse collectors in the unfiltered air volume, the pulse collectors being axially between the elements and the tubesheet.

The tubesheet may have a dirty air side in the unfiltered air volume and an opposite clean air side in the clean air volume, in which the clean air side of the tubesheet is pulse collector free.

The filter elements can include tubular elements having pleated filter media, the tubular elements having an open filter interior to receive filtered air, the open filter interior being in air flow communication with an interior volume of the pulse collectors.

The system may include pulse generator arranged to periodically emit gas pulses from the filtered air volume, through the tubesheet apertures, through the pulse collectors, and into the filter elements.

The pulse collectors can have a passageway that extends through the pulse collector from a filter end opening at a filter end of the pulse collector element to a tubesheet opening at a tubesheet end of the pulse collector.

The pulse generator can be configured to deliver the pulses of air along a pulse axis that extends from the pulse generator through the aperture in the tubesheet, the tube sheet opening in the pulse collector, and the filter end opening in the pulse collector, wherein the pulse generator comprises a pulse outlet located on the pulse axis and through which the pulses of air are delivered along the pulse axis, the pulse outlet defined by opposing walls that do not diverge with respect to the pulse axis, and wherein the pulse outlet defines a pulse outlet hydraulic diameter; and a pulse distance is measured along the pulse axis from the pulse outlet to the filter element opening and is 30 or more times the pulse outlet hydraulic diameter.

The pulse distance can be 60 times or less the pulse outlet hydraulic diameter.

The pulse distance can be 35 or more times the pulse outlet hydraulic diameter.

The pulse distance can be 50 times or less the pulse outlet hydraulic diameter.

A hydraulic diameter of the filter element opening may be 112% or less of a hydraulic diameter of the filter end opening of the pulse collector.

The hydraulic diameter of the filter element opening can be 90% or more of the hydraulic diameter of the filter end opening of the pulse collector.

The hydraulic diameter of the filter element opening can be 108% or less of the hydraulic diameter of the filter end opening of the pulse collector.

The hydraulic diameter of the filter element opening can be 95% or more of the hydraulic diameter of the filter end opening of the pulse collector.

An absolute value of a difference between a hydraulic diameter of the filter element opening and a hydraulic diameter of the filter end opening of the pulse collector can be within 2% or less of the hydraulic diameter of the filter element opening.

In some implementations, the inlet arrangement defines an inlet flow face, and the outlet hood defines an outlet flow face. The inlet flow face and the outlet flow face can be angled 45-135° relative to each other. The plurality of filter elements may comprise a first stage. The intake system can further include a second stage of filter elements downstream of the first stage, and the outlet hood will be free of the first and second stages of filter element arrangements.

In another aspect, a method of retrofitting a gas turbine air intake system is provided. The system can have a housing having a dirty air inlet, a filtered air outlet, and an internal volume; a tubesheet arranged in the housing volume, the tubesheet dividing the volume between a unfiltered air volume and a filtered air volume; the tubesheet having a plurality of apertures; and a plurality of pulse collectors (which can be Venturi elements) mounted in communication with the apertures in the tubesheet in the filtered air volume. The method may include removing the pulse collectors (such as Venturi elements) from the tubesheet; mounting a plurality of pulse collectors in the unfiltered air volume in communication with the apertures in the tubesheet; and mounting a plurality of filter elements in the unfiltered air volume in communication with the pulse collectors such that the pulse collectors are axially between the filter elements and the tubesheet.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is partially exploded perspective view one embodiment of a filtration system for a gas turbine air intake, constructed in accordance with principles of this disclosure;

FIG. 2 is a side view of the system of FIG. 1;

FIG. 3 is a front view of the system of FIG. 1 with a front skirt removed, the view being shown at section A-A in FIG. 2;

FIG. 4 is a top view of the system of FIG. 1;

FIG. 5 is a side cross-sectional view of the system of FIG. 1, the cross-section being taking along the line B-B of FIG. 4;

FIG. 6 is a schematic side view of another embodiment of a filtration system for a gas turbine air intake, constructed in accordance with principles of this disclosure;

FIG. 7 is a schematic side view of another embodiment of a filtration system for gas turbine air intake, constructed in accordance with principles of this disclosure;

FIG. 8 is a schematic side view of another embodiment of a filtration system for a gas turbine air intake, constructed in accordance with principles of this disclosure;

FIG. 9 is a schematic side view of another embodiment of a filtration system for a gas turbine air intake, constructed in accordance with principles of this disclosure;

FIG. 10 is a schematic side view of another embodiment of a filtration system for a gas turbine air intake, constructed in accordance with principles of this disclosure;

FIG. 11 is a schematic perspective view of another embodiment of a filtration system for a gas turbine air intake, constructed in accordance with principles of this disclosure;

FIG. 12 is s a schematic diagram of one illustrative embodiment of a relationship between a pulse generator and a filter element attached to a pulse collector in a filtration system as described herein;

FIG. 13 is a cross-sectional view of one illustrative embodiment of a relationship between a pulse collector and a filter element at a junction between the pulse collector and the filter element;

FIGS. 14A and 14B depict illustrative embodiments of offsets between the inner surfaces of a pulse collector and a filter element in an air filter system as described herein;

FIG. 15 depicts one illustrative embodiment of a pulse collector including a pulse section and a filter section as described herein;

FIG. 16 is a cross-sectional view of the pulse collector of FIG. 16 taken along line 16-16 in FIG. 15;

FIG. 17 is an enlarged cross-sectional view of one embodiment of a junction in the pulse collector depicted in FIG. 16;

FIG. 18 is a perspective view of an example embodiment of a pulse collector installed in a tube sheet usable with filtration systems described herein;

FIG. 19 is a side view of the embodiment of FIG. 18;

FIG. 20 is a side cross-sectional view similar to FIG. 5, but showing an alternate embodiment;

FIG. 21 is a side cross-sectional view similar to FIG. 5, but showing an alternate embodiment;

FIG. 22 is a side cross-sectional view similar to FIG. 5, but showing an alternate embodiment;

FIG. 23 is a side cross-sectional view similar to FIG. 5, but showing an alternate embodiment;

FIG. 24 is a side cross-sectional view similar to FIG. 5, but showing an alternate embodiment;

FIG. 25 is a side cross-sectional view similar to FIG. 5, but showing an alternate embodiment;

FIG. 26 is a side cross-sectional view similar to FIG. 5, but showing an alternate embodiment; and

FIG. 27 is a side cross-sectional view similar to FIG. 5, but showing an alternate embodiment.

### DETAILED DESCRIPTION

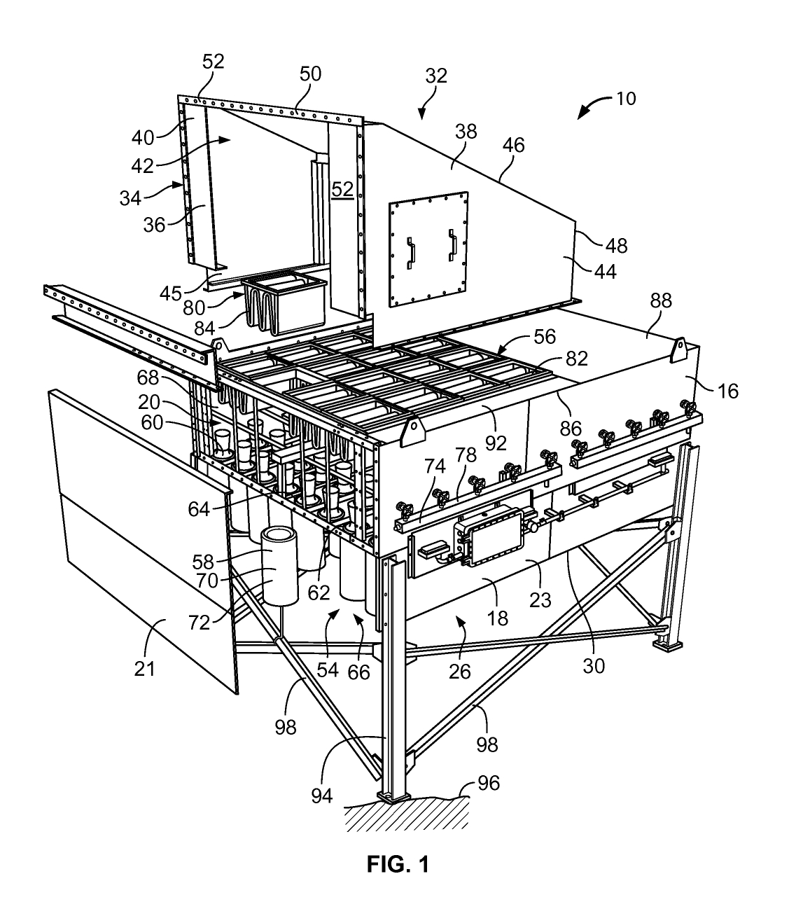

### A. The Example System of FIGS. 1-5

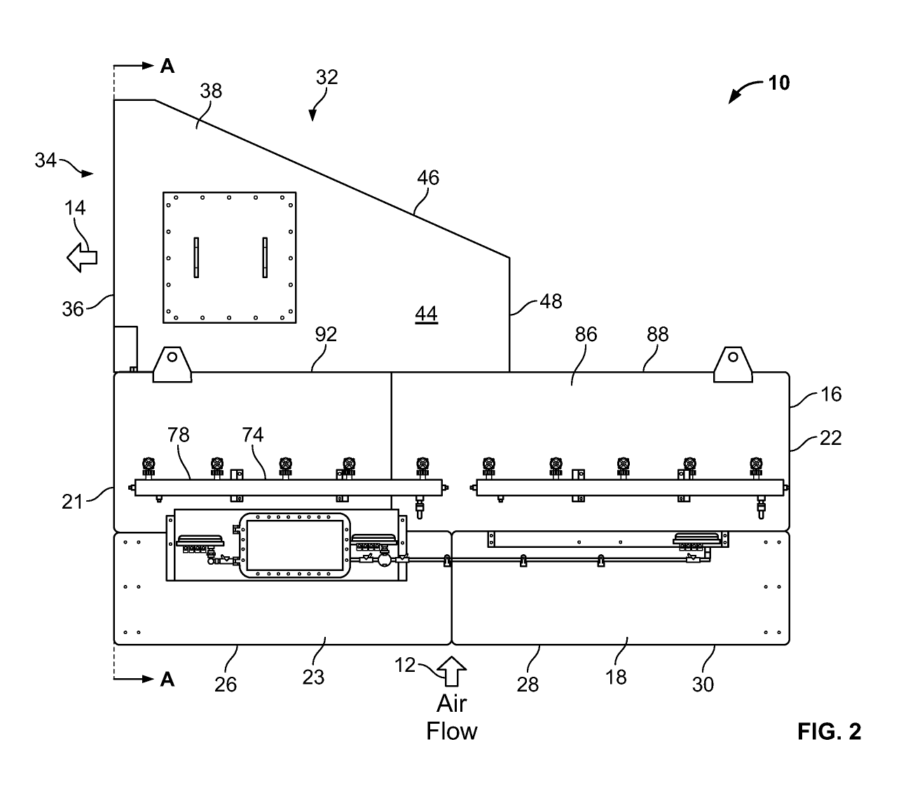

With reference to FIG. 1, a filtration system 10 for a gas turbine air intake is provided. In FIG. 2, the system is shown in side view. Air to be filtered is shown at arrow 12. The air 12 passes through the system 10, where it is filtered and then exits the system 10 at arrow 14, where it is then directed to a gas turbine (not shown).

In reference again to FIG. 1, in the embodiment shown, the system 10 includes a housing 16. The housing 16 includes a surrounding skirt 18. Inside of the skirt is an interior 20.

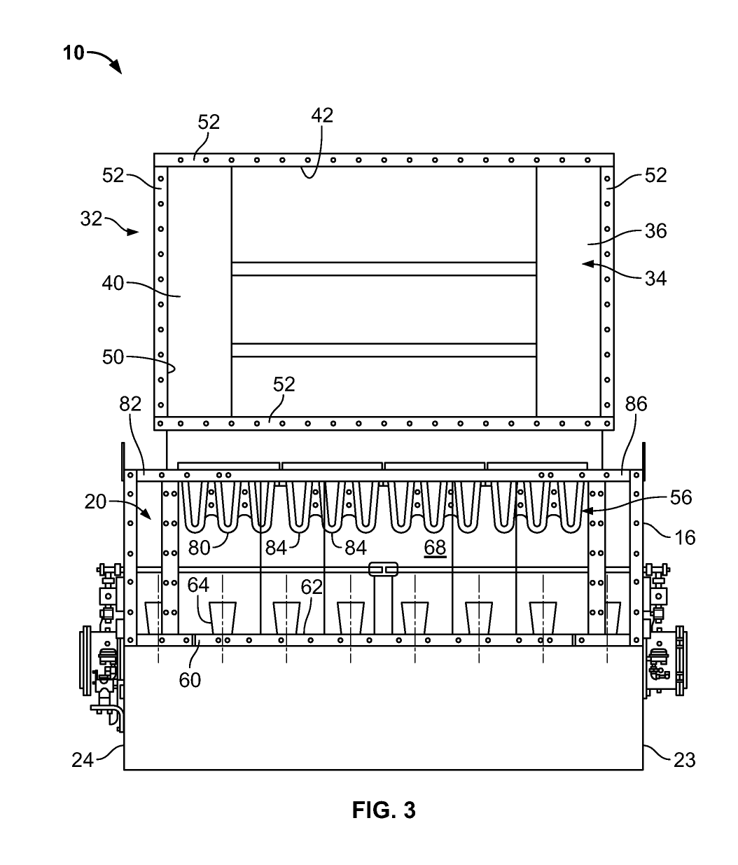

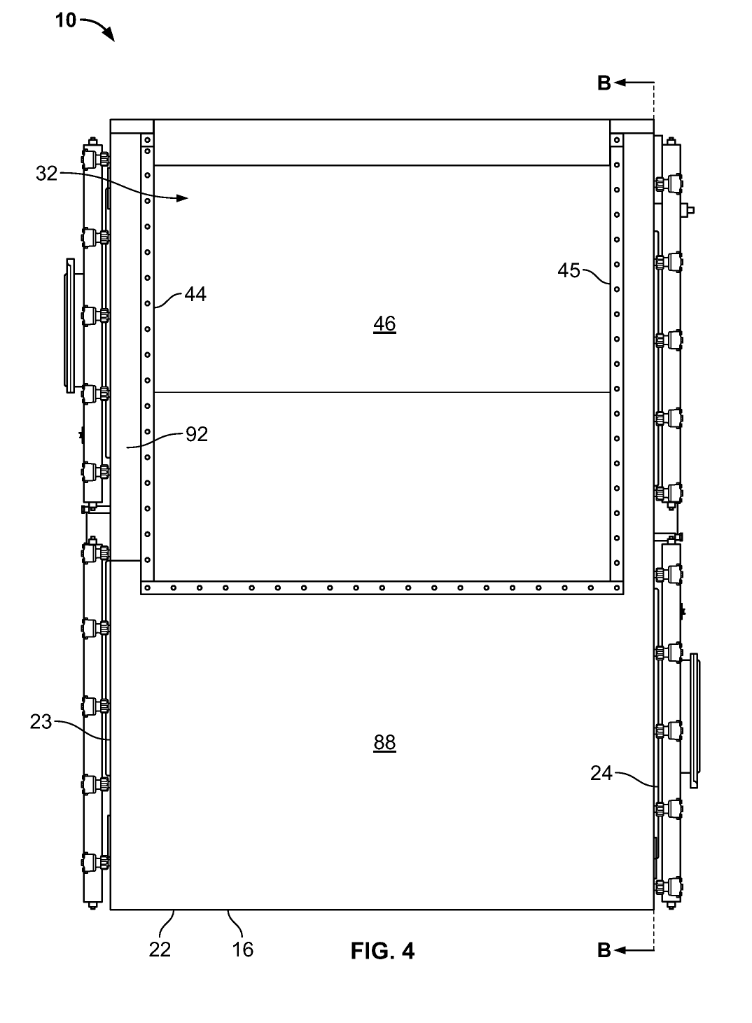

In one example embodiment, the skirt 18 includes a front panel 21, a rear panel 22 (FIGS. 2-5), a first side panel 23, and a second side panel 24 (FIGS. 3 and 4). In one example, the panels 21-24 can be made from a sheet metal.

The system 10 includes an inlet arrangement 26. The inlet arrangement 26 defines an inlet flow face 28. In general, the inlet flow face 28 can be approximated by the inner perimeter area defined by the lower edge 30 of the skirt 18. In this embodiment, the inlet flow face 28 is generally horizontal, when the system 10 is oriented in the configuration as shown in FIG. 1.

The inlet arrangement 26 is generally for taking in unfiltered air into the system 10. The system 10 removes particulate, including moisture droplets and debris, from the air before it exits at arrow 14, where it is then used for combustion by a gas turbine.

The system 10 further includes an outlet hood 32. The outlet hood 32 includes an outlet arrangement 34 defining an outlet flow face 36.

In the example embodiment shown, the outlet hood 32 includes a hood wall 38 and an opening 40. The hood wall 38 defines an outlet flow plenum 42 which is in communication with the interior 20 of the housing 16.

In the particular example shown, the hood wall 38 includes first and second sides 44, 45, opposing and spaced from each other, with a slanted roof 46 extending between the sides 44, 45. Also extending between the first and second sides 44, 45, and in opposition to the opening 40, is a rear side 48. The opening 40 can include an opening face 50 forming a periphery of the opening 40.

In this example, the outlet flow face 36 is formed by the perimeter area defined by the opening face 50. As can be seen in this particular example, the outlet flow face 36 is in a generally vertical plane, when the system 10 is oriented in the orientation shown in FIG. 1.

The opening face 50 defines flanges 52 that will allow the outlet hood 32 to be easily connected or bolted to existing or new duct work, leading to a gas turbine system.

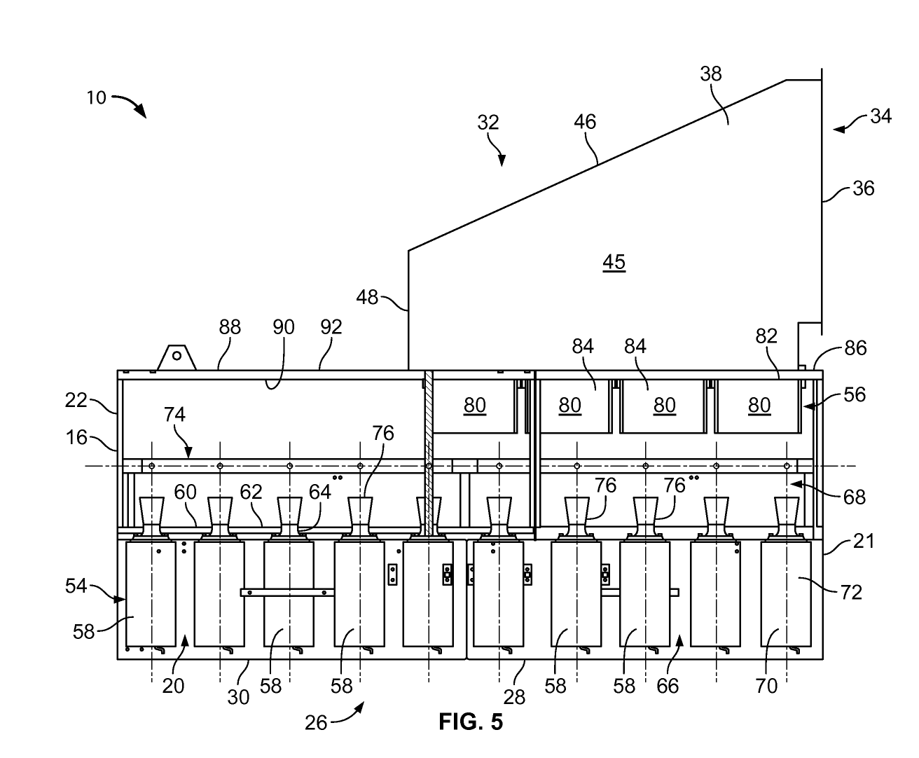

In general, the inlet flow face 28 and the outlet flow face 36 will be angled relative to each other. For example, the inlet flow face 28 and the outlet flow face 36 will be angled 45-135° relative to each other. Such angling of one relative to other allows for systems that can be easily adjusted to be retrofitted into existing systems and/or to accommodate more or less stages of filtration, depending upon what is needed in the particular environment of use. In some arrangements, the inlet flow face 28 and the outlet flow face 36 are angled about 70-110° relative to each other. In the particular example shown in FIGS. 2 and 5, the inlet flow face 28 and the outlet flow face 36 are angled 85-95° relative to each other, for example, about 90° relative to each other.

The system 10 includes at least a first stage filter element arrangement 54 and a second stage filter element arrangement 56 held within the interior 20 of the housing 16. The first and second stages 54, 56 are operably sealed within the housing 16 such that air flowing through the inlet arrangement 26 must pass through the first and second stages 54, 56 before exiting through the outlet arrangement 34. By the term “operably sealed” it is meant that the filter element arrangements are held and sealed within the housing 16 in a way that allows for the air to flow through the housing 16 and through the filter element arrangements 54, 56 so that the air is filtered by the filter element arrangements 54, 56. The first and second filter element arrangements 54, 56 may be removably sealed within the housing 16. Examples of first stage filter element arrangement 54 and second stage filter element arrangement 56 are described further below.

The outlet hood 32 is free of the first and second stages of filter element arrangements 54, 56. That is, the outlet hood 32, in preferred embodiments, does not hold or house either of the first stage filter element arrangement 54 or the second stage filter element arrangement 56. In some alternative embodiments, the outlet hood 32 may include some additional filtration, but the outlet hood 32 does not include the first and second stages 54, 56.

The housing 16 can include a base structure 94 (FIG. 1), which holds the first stage filter element arrangement 54 spaced vertically above a base surface 96. The base structure 94 can be a frame structure 98 secured to the remaining portion of the housing 16. As can be appreciated from a review of FIG. 1, the inlet flow face 28 is between the base surface 96 and the first stage filter element arrangement 54.

In one example, the first stage filter element 54 includes a plurality of filter elements 58 operably held by a first tubesheet 60 in the interior 20 of the housing 16. The first tubesheet 60, in the example of FIGS. 1, 3, and 5, is a panel or partition 62 including apertures 64. Each aperture 64 holds an individual filter element 58, which is sealed against the partition 62. The first tubesheet 60 divides the interior 20 between an unfiltered air volume 66 and a filtered air volume 68. In the embodiment shown in FIGS. 1, 3, and 5, the first tubesheet 60 is generally horizontal, when shown in the orientation as depicted in FIG. 1. The tubesheet 60 is also, in this example embodiment, generally parallel to the inlet flow face 28.

Many different embodiments of filter elements 58 can be used. In the embodiment shown in FIG. 1, the filter elements 58 are depicted as cylindrical elements 70 having pleated media 72. For example, usable filter elements 58 include those described in U.S. Pat. No. 5,562,746, incorporated herein by reference. Other types of elements could include panel elements of pleated, depth, or Z-media; v-packs of pleated, depth, or Z-media; pocket filters; mini-pleats, etc.

The system 10 can include a pulse jet system 74 within the interior 20 of the housing 16 disposed to periodically send a blast of fluid to the first stage filter element arrangement 54. For example, the pulse jet system 74 can be oriented such that a jet of air is periodically blasted from the downstream side of the filter elements 58 through the upstream side, to remove any caked on particulate or debris. The pulse jet system 74 can include Venturi members 76 to help direct the pulse jet to the downstream side of the media through a media to the upstream side. In FIGS. 1 and 2, the pulse jet system 74 can be seen with system components 78.

In alternate systems, the system 10 will be a static system that is free of a pulse jet cleaning system.

The second stage filter element arrangement 56 can include a variety of different types of filter elements. In the example shown in FIGS. 1-5, the second stage filter element arrangement 56 includes a plurality of filter elements 80. The filter elements 80 are operably held by a second tubesheet 82 in the interior 20 of the housing 16. The second tubesheet 82 is downstream of the first tubesheet 60.

In one example, the first tubesheet 60 is +/−45° of being parallel to the inlet flow face 28, and the second tubesheet 82 is spaced from the first tubesheet 60 and is +/−30° of being parallel to the first tubesheet 60. In the example shown in FIG. 1, the first tubesheet 60 is approximately parallel to the inlet flow face 28, and the second tubesheet 82 is about parallel to the first tubesheet 60.

While a variety of different arrangements can be used for the filter elements 80 that are part of the second stage filter element arrangement 56, in the particular example shown in FIG. 1, the filter elements 80 are non-cylindrical elements.

In non-limiting examples, the filter elements 80 in the second stage arrangement 56 are non-panel shaped media packs. In other arrangements, the filter elements 80 can be cylindrical. In other arrangements, the filter elements 80 can be panel shaped elements.

In the particular example illustrated in FIG. 1, the second stage filter element 56 includes elements 84 having a wave-shaped cross-section of pleated media. In one non-limiting example, elements 84 that can be utilized are described in U.S. Patent Publication US 2011/0067368, published Mar. 24, 2011, and incorporated herein by reference. In other embodiments, the second stage elements 80 can be v-packs, pocket elements, mini-pleats, panel filters, z-media, tubular filters, etc.

In the example shown in FIG. 1, the second tubesheet 82 is at or adjacent to the top edge 86 of the skirt 18 of the housing 16. In the example shown, the second stage filter element arrangement 56 is oriented vertically above the first stage filter element arrangement 54. While there can be an angle between the two, in the example shown, the first stage 54 and second stage 56 are generally parallel to each other.

Attention is directed to FIG. 5. In FIG. 5, in the example shown, the first stage 54 can be seen relative to the second stage 56. By comparing FIG. 1 and FIG. 5, it can be appreciated that the second stage 56 has a horizontal footprint that is smaller than a horizontal footprint of the first stage 54. That is, the first stage filter element arrangement 54 occupies most of the volume of the interior 20 between front panel 21 and rear panel 22, as well as between first and second side panels 23, 24 of the skirt 18. In contrast, the second stage 56 occupies only a portion of the interior 20 between the front panel 21 and rear panel 22. In the example shown, the second stage 56, in this example, extends between the first side panel 23 and second side panel 24, but it extends only partially from the front panel 21 to the rear panel 22.

In the example shown in FIGS. 1 and 5, the second stage 56 extends less than 100%, for example between 40-70% of the extension of the horizontal footprint of the first stage element 54. In the example of FIGS. 1 and 5, the second stage arrangement 56 extends from the front panel 21 about 45-65% to the rear panel 22. Thus, in the embodiment shown in FIGS. 1 and 5, the housing 16 includes a top panel 88, which extends between and end of the second stage 56 and the rear panel 22. The top panel 88 covers the first stage 54 and defines a plenum 90 (FIG. 5) between the first tubesheet 60 and the top panel 88 leading to the second stage 56.

In the example shown, the outlet hood 32 forms a horizontal footprint defined as an inside periphery of the hood wall 38. That is, in the example embodiment shown, the outlet hood 32 has a horizontal footprint defined by an inner periphery of the first side 44, second side 45, rear side 48, and along the front edge 51 of the opening face 50. The horizontal footprint of the outlet hood 32 is preferably within about 20% of a size of the horizontal footprint of the second stage filter arrangement 56. In many preferred arrangements, the horizontal footprint of the outlet hood 32 and of the second stage filter arrangement 56 are within 10% of each other, and can be about the same size as each other.

From a review of FIGS. 1 and 2, it can be appreciated that the horizontal footprint of the outlet hood 32 is less than the horizontal footprint of the first stage filter arrangement 54. In the example shown, the horizontal footprint of the outlet hood 32 extends from the front panel 21 not more than 80% of the distance toward the rear panel 22 across a top 92 of the housing 16. In many preferred arrangements, the outlet hood 32 extends less than 75% of the distance across the top of 92 of the housing 16 between the front panel 21 and rear panel 22. Typically, the outlet hood 32 extends at least 15% of the distance across the top 92 of the housing 16 between the front panel 21 and rear panel 22, and can extend between 45-100% of the distance across the top 92 of the housing 16.

In operation, to filter incoming air, the unfiltered air enters the system 10 at arrows 12 (FIG. 2). As can be seen, the air entering system 10, in this embodiment, is located below the first stage filter element arrangement 54. In this embodiment, the air 12 enters through the inlet arrangement 26 having inlet flow face 28. The inlet flow face 28, in this particular embodiment, is generally horizontal.

After the air enters the system 10 through the inlet flow face 28, the air is directed through the first stage filter element arrangement 54. When the first stage filter element arrangement 54 includes cylindrical filter elements 70, the air flows from the outside of the elements, through the filter media, and into the interior of each of the elements 70. From there, the air flows into filtered air volume 68. At least some of the air in the filtered air volume 68 is within plenum 90 between the top panel 88 and the first tubesheet 60. The filtered air in the filtered air volume 68, including the air in the plenum 90 is then directed through the second stage filter element arrangement 56. The air flows through the filter media in the second stage filter element arrangement 56 and is then directed into the plenum 42 of the outlet hood 32. The clean filtered air then flows through the outlet flow face 36 of the outlet arrangement 34, where it is then directed to a gas turbine system for combustion.

During the step of directing the air through the outlet hood 32, the outlet flow face 36 is angled 45-135° relative to the inlet flow face 28. In many typical arrangements, this angle would be 80-100°, approximately 90°. The outlet hood 32 will be free of both the first and second stages 54, 56, which enhances flexibility of the system 10.

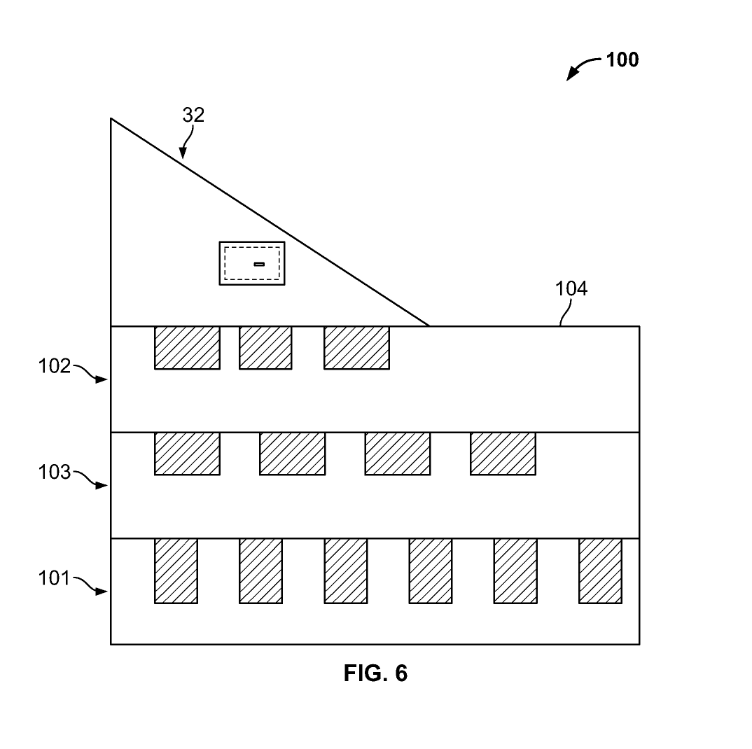

### B. Example Systems of FIGS. 6-10

The system 10 is arranged so that it is adapted to be flexible enough to accommodate more than just first and second stages 54, 56. In FIG. 6, there is a system 100 that has, in addition to the first stage 101 and second stage 102, a third stage 103 of a filter element arrangement operably sealed within the housing 104. The system 100 is constructed analogously to the system 10, but is modified to include, within the same original horizontal footprint of housing 16, the third stage 103. That is, the housing 104 can be built by modifying the housing 16 to include additional height to the skirt 18 in order to accommodate a plurality of additional stages of filter elements. In FIG. 6, the third stage 103 is illustrated, but it should be understood that there can be more than three stages, with each of the additional stages being either upstream or downstream of the other stages in the housing 104. In the example of FIG. 6, the third stage 103 is shown between the first stage 101 and second stage 102. The additional stages would be accommodated within the housing 104, without extending beyond the horizontal footprint of the housing 104 (or housing 16, as illustrated in FIGS. 1-5).

In FIG. 6, the elements within each of the stages can be a variety of types of filter elements, depending upon the environment of use and the particular objectives.

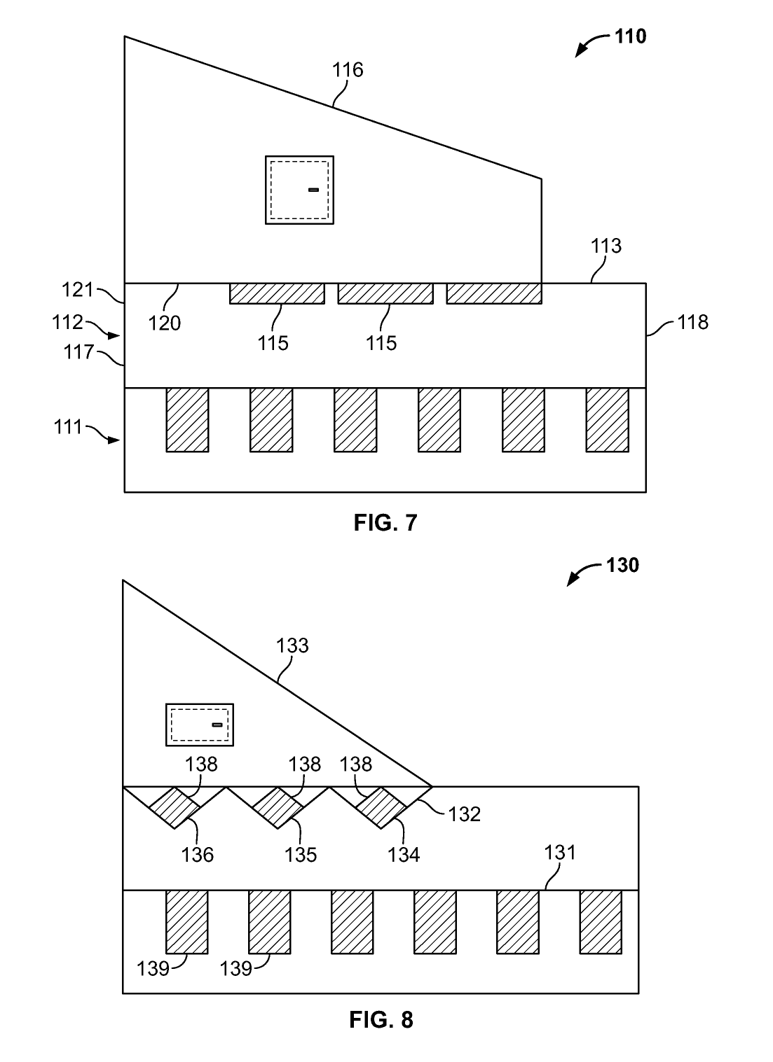

FIG. 7 illustrates another system 110. In FIG. 7, the first stage is shown at 111 and the second stage is shown at 112 within housing 113. Again, the system 110 is analogous to the system 10, and description thereof is incorporated herein by reference. One difference between the system 10 and system 110 is that the second stage 112 in this embodiment is illustrated as having panel filters 115. The outlet hood 116 extends a distance to cover the second stage 112, and does not extend a full length of the housing 113 between a front panel 117 and rear panel 118.

In FIG. 7, the second tubesheet 120 is generally centered between the front panel 117 and rear panel 118. That is, instead of having filter elements right up to the front edge 121, as shown in the system of FIG. 1, in FIG. 7, because the second tubesheet 120 is centered, the panel filter elements 115 are spaced from the front edge 121.

While in previous embodiments, the tubesheets have been shown to be generally planar, they do not necessarily have to be so. For example, FIG. 8 illustrates a system 130 having first and second tubesheets 131, 132, with second tubesheet 132 being non-planar. In the embodiment shown, the second tubesheet 132 has a series of steps 134, 135, 136 to be saw-tooth shaped. Each step 134, 135, 136 operably holds a filter element 138. The first tubesheet 131 holds elements 139, which can be many different types of elements including cylindrical pleated elements, such as shown in connection with FIG. 1. The elements 138 held by the second tubesheet 132 can be many different types of elements including, for example, panel elements, pocket filters, v-packs, wave-shaped, etc. Other than the shape of the second tubesheet 132, the system 130 is analogous to the system 10 of FIGS. 1-5, and the description is incorporated herein by reference. The system 130 includes an outlet hood 133.

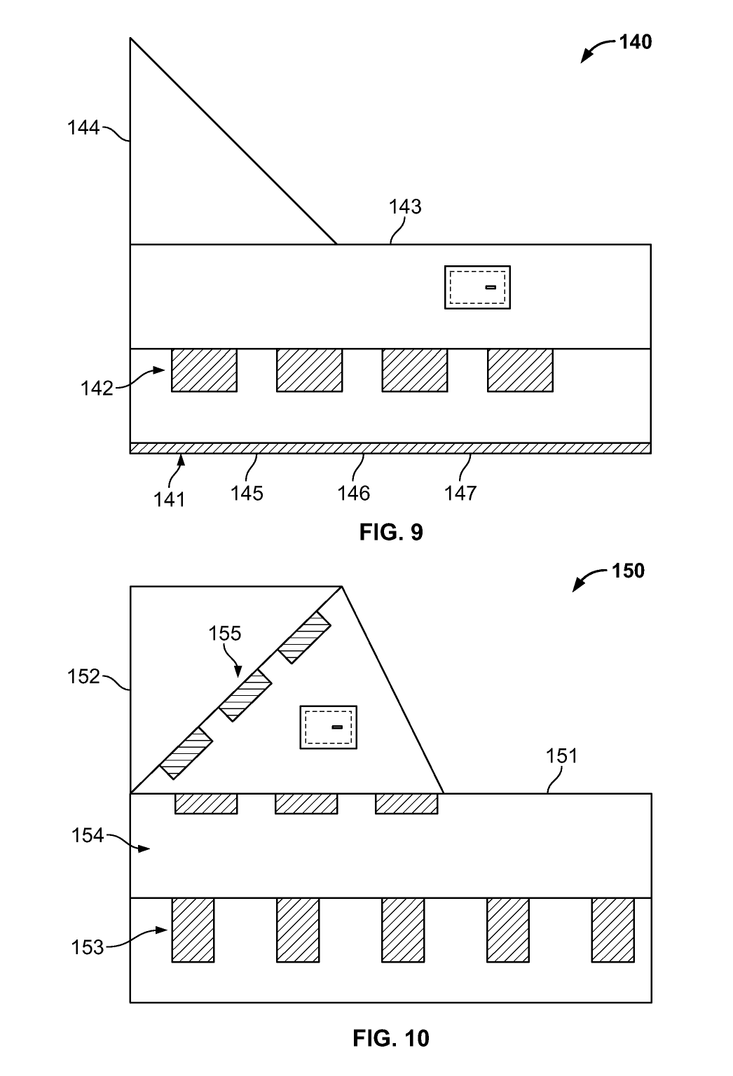

FIG. 9 shows another embodiment of a system at 140. The system 140 is analogous to the system 10, in that it has first and second stages 141, 142 in a housing 143. An outlet hood 144 directs the filtered air from the housing 143.

In the embodiment of FIG. 9, one of the at least first and second stages 141, 142 includes a pre-filter arrangement 145 at or adjacent to the inlet arrangement 146. In the particular example shown in FIG. 9, the first stage 141 is also the pre-filter arrangement 145.

The pre-filter arrangement 145 can be many different types of filters including a porous screen 147. The screen 147 can be in place to prevent birds, tree branches, leaves, and large debris, for example, from being drawn into the housing 143.

After the air passes through the pre-filter arrangement 145, it then passes through the second stage 142. From there, in the embodiment shown, the air is directed through the hood 144 and exits the system 140. There can be at least one or more than one stage downstream of the pre-filter arrangement 145, but in the embodiment of FIG. 9, only a single stage downstream of the pre-filter arrangement 145 is illustrated.

FIG. 10 illustrates another embodiment of an air intake filter system at 150. The system 150 is analogous to the system 10, and the description of the system 10 is incorporated herein by reference. The system 150 includes housing 151, outlet hood 152, and a plurality of stages of filter arrangements. In the FIG. 10 embodiment, there are three stages illustrated, the first stage at 153, second stage at 154 and third stage at 155.

In the system 150, the third stage 155 is held within the hood 152. The elements in the third stage 155 can be many different types of filter elements including panel filters made of pleated media, depth media, or z-media; wave-shaped elements, pocket filters, v-packs, or cylindrical elements, etc. It should be understood that the illustrated embodiment of FIG. 10 shows only first and second stages 153, 154 upstream of the third stage 155, but in other embodiments, there can be more than just the first and second stages 153, 154.

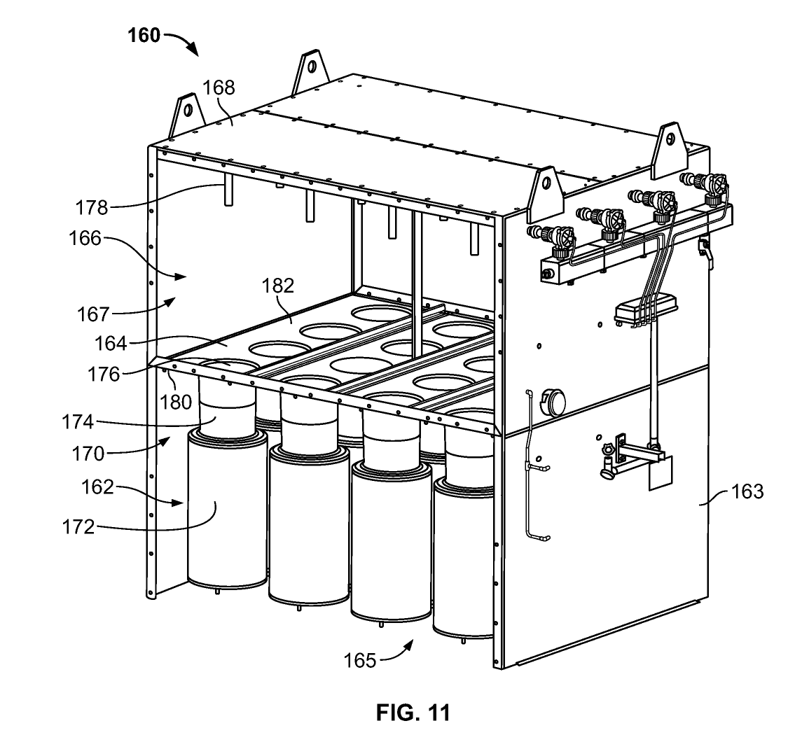

### C. Example Embodiments of FIGS. 11-16

1. The System of FIG. 11

FIG. 11 depicts an example embodiment of another intake filter system 160. The system 160 depicts a single stage (first stage) at 162 within a housing 163, but it should be understood that a second stage similar to second stage 56 of FIG. 1 can be part of this embodiment within housing 163, even though not shown in FIG. 11. This embodiment is illustrated to demonstrate an arrangement for advantageous filtering, especially when using with reverse pulse cleaning.

The system 160 includes a tubesheet 164 that may be oriented generally horizontally to separate an internal volume 167 of the housing 163 between a filtered air volume 166 in an outlet hood 168 located above the tubesheet 164, and an unfiltered air volume 170 located below the tubesheet 164. The outlet hood 168 is free of the first stage 162 and, if depicted, a second stage of filter element arrangements. The housing 163 has an inlet arrangement 165 for the intake of dirty, or unfiltered, air. After passing through at least the first stage filter element arrangement 162, the clean, or filtered air, exits through the outlet hood 168.

The first stage filter element arrangement 162 includes filter elements 172 attached to the tubesheet 164 through an arrangement of non-porous, non-perforated tubes, or pulse collectors 174. Unfiltered air entering the unfiltered air volume 170 passes through the filter elements 172 and the pulse collectors 174 before entering the filtered air volume 166 above the tubesheet 164. The tubesheet 164 includes apertures 176 over which the pulse collectors 174 are attached such that air passing from the pulse collectors 174 passes through the apertures 176 in the tubesheet 164 when moving from the pulse collectors 174 into the filtered air volume 166.

The system 160 also includes pulse generators 178 located in the filtered air volume 166 and are configured to direct pulses into the pulse collectors 174 through the apertures 176 in the tubesheet 164. The pulse from each of the pulse generators 178 enters the pulse collector 174 over which the pulse generator 178 is aligned and passes into the interior volume of the filter element 172 to remove particulate matter from that filter element 172 as described herein.

As mentioned above, the FIG. 11 embodiment is arranged for advantageous filtering when using with the pulse generators 178. In many prior art systems, there are pulse collectors 174, such as Venturi element s (or members) downstream of the tubesheet 174, in the filtered air volume 166. Pulse collectors 174 generally, and Venturis elements as examples, increase the velocity of the pulses used to reverse clean the filter elements 172.

To improve pulse cleaning, the distance between the pulse generators 178 and the elements 172 needs to be increased because the pulse can only expand at a certain rate before it starts diminishing. While Venturis work to increase the velocity of the pulse, the presence of Venturis or other types of pulse collectors 174 downstream of the tubesheet 174 cause a pressure drop since they are in the filtered air volume 166.

Thus, it has been discovered that to improve pulse cleaning by increasing the distance between the pulse generators 178 and the filter elements 172 in an existing system footprint, the elements 172 are spaced further upstream from the tubesheet 164, and non-porous, non-perforated tubes or pulse collectors 174 (which may also be in the form of Venturi elements) are placed in between the elements 172 and the tubesheet 164. Putting the pulse collectors 174 in the upstream side of the tubesheet 164 in the unfiltered air volume 170 has little effect on pressure drop, since there are already obstructions (e.g., the filter elements 172) in the unfiltered air volume 170. Removing Venturis from the filtered air volume 166 removes obstructions and pressure losses due to turbulence.

In FIG. 11, the tubesheet 164 has a dirty air side 180 and an opposite clean air side 182. The clean air side 182 is pulse collector-free (including Venturi-element free), and it is substantially structure-free. Indeed, the filtered air volume 166 is almost completely structure-free, with only a few frame members or parts of the pulse generators 178 present, which leads to improvements in pressure loss.

When systems are compared between: (A) prior art systems with Venturi elements or other pulse collectors on the downstream side of the tubesheet 164 to (B) systems 160 that have: (i) pulse collectors 174 upstream of the tubesheet 164, and (ii) are pulse collector-free and Venturi-free and other substantially obstruction-free downstream of the tubesheet 164 or at least partially free on the downstream side if Venturis, pulse collectors and other obstructions, there is increase cross-sectional area in system B for the primary air flow. For example, there can be at least twice the cross-sectional area in system B for primary air flow, and in many implementations, 3 times more cross-sectional area for primary air flow. In some embodiments, there can be 4 times more cross-sectional area for air flow, and indeed in at least one embodiment, there can be 5 times more cross-sectional area for air flow. The increase in cross-sectional area for primary air flow increases the air flow from system A by at least 100%, and in many embodiments by at least 150%; indeed, by at least 200% in some systems. In at least one embodiment, the increase in air flow over system A is 250%.

FIGS. 18 and 19 illustrate a variation of location of the pulse collector 174 relative to the tube sheet 164. In ideal conditions, the pulse collectors 174 are 100% located on the side of the tube sheet 164 that is part of the unfiltered air volume 170. In some alternate embodiments, a least a portion of the pulse collector 174 is located in the filtered air volume 166, while the remaining portion is located in the unfiltered air volume 170. FIG. 19 shows the length lp of the pulse collector 174. In preferred systems, the portion of lp extending into the filtered air volume 166 is less than or equal to 50%. Indeed, in many embodiments, the portion of lp extending into the filtered air volume 166 will be less than 40%, and many will be less than 25%. In still further embodiments, the portion of lp extending into the filtered air volume 166 will be less than 10%, and ideally, the portion of lp extending into the filtered air volume 166 will be 0%—that is, 100% of the pulse collector 174 will be in the unfiltered air volume 170.

2. Retrofitting

A method of retrofitting a gas turbine air intake system can be implemented following the principles herein. The existing system will typically have a housing, such as housing 163, having an unfiltered air inlet arrangement 165, a filtered air outlet at outlet hood 168, and an internal volume 167; the tubesheet 164 is arranged in the housing volume 167, the tubesheet 164 dividing the volume 167 between unfiltered air volume 170 and a filtered air volume 166; the tubesheet 164 having apertures 176; and a plurality of pulse collectors (which may be in the form of Venturi elements (not shown)) mounted in communication with the apertures 176 in the tubesheet 164 in the filtered air volume 166. The method can include removing the pulse collectors (which may be in the form of Venturi elements) from the tubesheet 164; mounting a plurality of pulse collectors, such as collectors 174 in the unfiltered air volume 170 in communication with the apertures 176 in the tubesheet 164; and mounting a plurality of filter elements 172 in the unfiltered air volume 170 in communication with the pulse collectors 174 such that the pulse collectors 174 are axially between the filter elements 172 and the tubesheet 164.

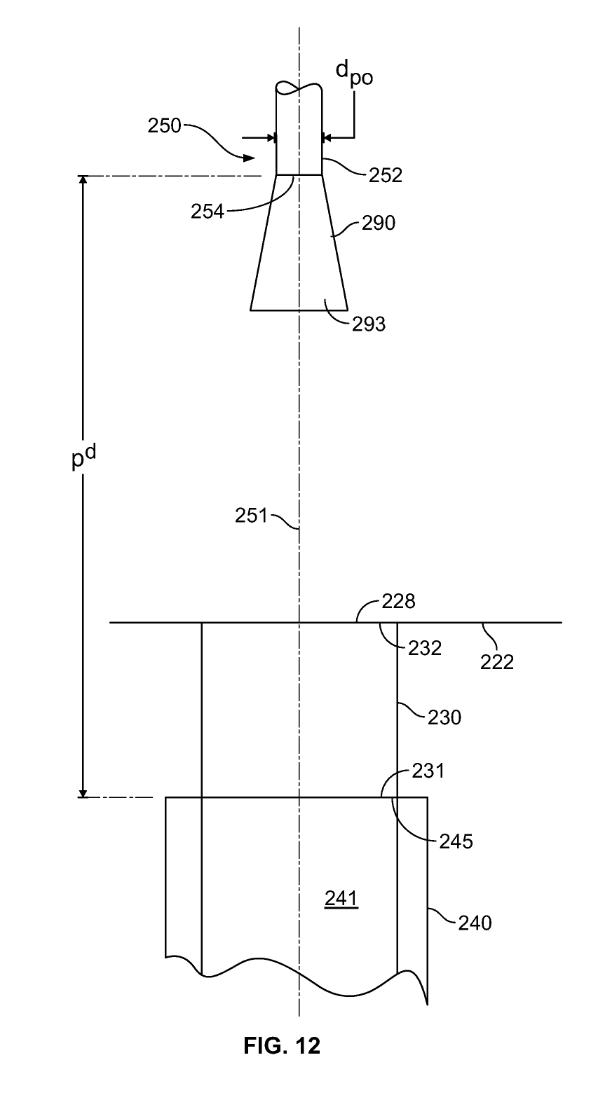

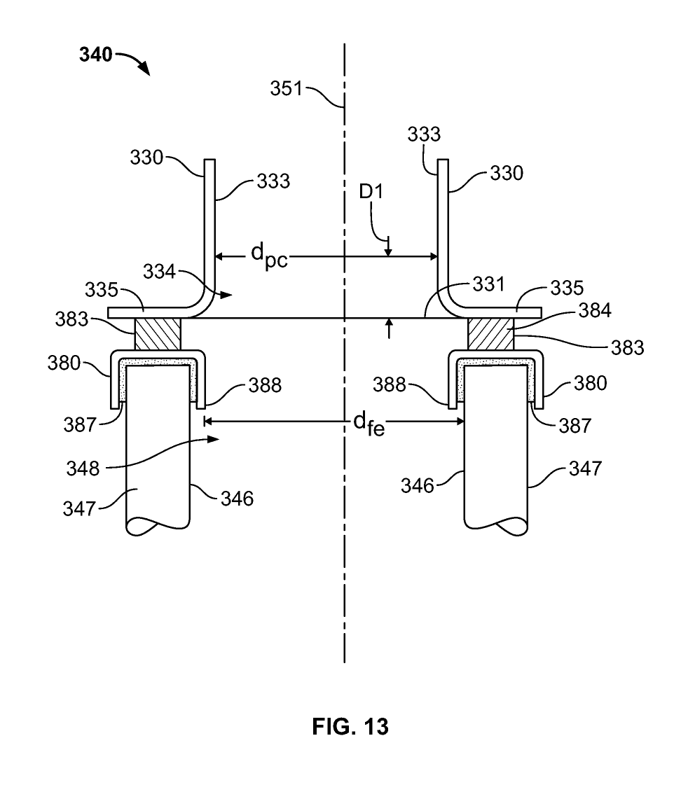

### 3. Example Advantageous Arrangements, FIGS. 12 and 13

In example embodiments of the air filter systems described herein, the distance between the pulse generators and filter elements may be selected to improve the cleaning or removal of particulate matter from the filter elements during use of the air filter systems. Referring to, e.g., FIG. 12, one illustrative embodiment of an arrangement between a pulse generator 250, tubesheet 222, pulse collector 230, and filter element 240 is depicted in the form of a simplified structure to more clearly illustrate and describe this feature.

In particular, the pulse collector 230 includes a filter end opening 231 at the end of the pulse collector element to which the filter 240 is attached. The filter element 240 includes a filter element opening 245 at the interface between the filter end opening 231 of the pulse collector 230 and the filter element 240. At the opposite end of the pulse collector 230, a tubesheet opening 232 is, in example embodiments, aligned with an aperture 228 in the tubesheet 222.

An example embodiment of pulse generator 250 depicted in FIG. 12 (which, for the sake of clarity, is not depicted in scale with the other components seen in FIG. 12) includes a pulse outlet 254 defined at the end of a delivery tube 252. The pulse generator 250 is configured to deliver pulses of air along a pulse axis 251 that extends from the pulse generator 250 through the aperture 228 in the tubesheet 222, the tubesheet opening 232 and the filter end opening 231 in the pulse collector 230. The pulse generator 250 includes a pulse outlet 254 located on the pulse axis 251 and through which the pulses of air are delivered along the pulse axis 251.

Although the pulse axis 251 in example embodiments of air filter systems described herein may be oriented and located such that the pulse axis 251 passes through a center of all of the pulse outlet 254, the aperture 228 in the tubesheet 222, the tubesheet opening 232 and the filter end opening 231 in the pulse collector 230, the filter element opening 245, and the interior volume 241 of the filter element 240, the pulse axis 251 may, in example embodiments, be positioned such that the pulse axis 251 does not pass through the center of one or more of those features/openings.

In example embodiments such as the one depicted in FIG. 12, a diverging pulse guide 290 is attached to the pulse generator 250 such that air leaving the pulse outlet 254 is at least partially contained within the diverging pulse guide 290 before exiting the diverging pulse guide 290 at its open end 293. The diverging pulse guide 290 depicted in FIG. 12 is only one example of a diverging pulse guide which may be used in connection with the air filter systems described herein. Other diverging pulse guides may be used such as, e.g., those described herein, as well as those described in, e.g., U.S. Provisional Patent Application No. 61/772,198, titled DIVERGING NOZZLES AND FILTER ELEMENT CLEANING SYSTEMS USING DIVERGING NOZZLES.

The pulse outlet 254 of the pulse generators described herein is the opening through which pulses pass that is defined by opposing walls in the pulse generator 250 that do not diverge. In the illustrative embodiment depicted in FIG. 12, the pulse outlet 254 is defined by the walls of delivery tube 252 which may be parallel to each other. In one or more alternative embodiments, however, the walls of delivery tube 252 leading to the pulse outlet 254 may be converging. The pulse outlet 254 is not, however, defined by walls that are diverging as are the walls defining the diverging pulse guide 290 attached to the pulse generator 250. The converging or diverging orientation of the opposing walls defining the pulse outlets in pulse generators described herein are determined with respect to the pulse axes passing through the pulse generators, i.e., when not parallel to each other, the converging or diverging nature of the opposing walls is determined with when moving along the pulse axis in a direction towards the filter elements.

The relationship between the pulse generator and filter element in air filter systems as described herein is, in example embodiments, related to the pulse distance (pd as seen in FIG. 12) and the pulse outlet hydraulic diameter (dpo as seen in FIG. 12).

The pulse distance (pd) is the distance measured along the pulse axis 251 from the pulse outlet 254 to the filter element opening 245. The pulse axis 251 extends from the pulse outlet 254 through the aperture 228, pulse collector 230 and into the interior volume 241 of the filter element 240. In example embodiments in which the delivery tube 252 defines the pulse outlet 254 with walls that are parallel to each other, the pulse axis 251 may be aligned with those parallel walls.

The hydraulic diameter (dpo) of the pulse outlet 254 can be determined by measuring the cross-sectional area of the pulse outlet 254, multiplying that area by four, and then dividing the resultant by the length of the perimeter of the pulse outlet 254. Calculation of the hydraulic diameter of a pulse outlet is represented by the following equation.

dpo=4*(area of pulse outlet)/perimeter of pulse outlet

In example embodiments of air filter systems described herein, the hydraulic diameter (dpo) of the pulse outlets may be as small as, e.g., 8 millimeters and as large as, e.g., 150 millimeters. The sizing of the pulse outlets will vary depending on many different factors such as, e.g., the size of the filter elements, flow rates through the system, etc.

The lower end of the range for the pulse distance (pd) may be 30 or more times the pulse outlet hydraulic diameter (dpo). In one or more alternative embodiments of the air filter systems described herein, the lower end of the range for the pulse distance (pd) may be 35 or more times the pulse outlet hydraulic diameter (dpo). The upper end of the range for the pulse distance (pd) may be 60 times or less the pulse outlet hydraulic diameter (dpo). In example embodiments of the air filter systems described herein, the upper end of the range for the pulse distance (pd) may be 50 times or less the pulse outlet hydraulic diameter (dpo).

One or more embodiments of the air filter systems described herein may also be characterized in terms of a relationship between hydraulic diameters of the filter element openings and the filter and openings of the pulse collectors to which the filter elements are attached. A simplified schematic diagram of the junction between a pulse collector 330 and a filter element 340 that are located along a pulse axis 351 is depicted in FIG. 13 and will be used to describe the relationship between those hydraulic diameters.

As depicted in FIG. 13, the pulse collector 330 includes an inner surface 333 that defines the filter end opening 331 of the pulse collector 330. The pulse collector 330 may include a flange 335 that can be used as a surface against which a filter element can be sealed during use of the air filter systems described herein.

The filter element 340 depicted in FIG. 13 includes filter media 347 to which an end cap 380 is connected. In example embodiments, the end cap 380 may be configured to receive the filter media 347 such that an air-tight connection is provided between the filter media 347 and the end cap 380. In the depicted illustrative embodiment, sealant 387 in the form of, e.g., potting material may be used to provide an air-tight connection between the end cap 380 and the filter media 347 (although many other air-tight connections could be used to secure an end cap to filter media); for example, the end cap 380 may be directly molded to the filter media 347.

The filter media 347 can be many different types of media including, for example, pleated media having an open filter interior 348 defined by inner media surface 346. The open filter interior 348 receives filtered air and is in air flow communication with an interior volume 334 of the pulse collectors 330.

A seal member or gasket 383 is, in the depicted illustrative embodiment, located between the flange 335 of the pulse collector 330 and the end cap 380 to form a seal 384 between the pulse collector 330 and the filter element 340. The seal 384, in this embodiment, is an axial seal. In the air filter systems described herein, one or more gaskets or other sealing structures may be used to seal the connection between a filter element and a pulse collector.

The hydraulic diameter of the filter element opening (dfe) may be related to the hydraulic diameter of the filter end opening of the pulse collector (dpc).

The hydraulic diameter (dpc in FIG. 13) of the filter end opening of the pulse collectors described herein can be determined in a plane that is transverse to the pulse axis 351 at a location within 25 millimeters or less of the filter end opening 331 of the pulse collector 330 along the pulse axis 351 where the cross-sectional area of the passageway through the pulse collector 330 is smallest. With reference to FIG. 13, it is the distance D1 that is 25 millimeters or less. As a result, minor changes in the cross-sectional area of the passageway through the pulse collector 330 near the junction of the pulse collector and the filter element 340 (such as, e.g., curvature of the pulse collector 330 at its filter end opening where the pulse collector 330 widens due to, e.g., manufacturing requirements) will not affect an accurate determination of the hydraulic diameter dpc of the pulse collector 330 as described herein. The hydraulic diameter dpc of the filter end opening of the pulse collector 330 is calculated according to the equation described above in connection with the hydraulic diameter of the pulse outlet, i.e., the hydraulic diameter is four times the cross-sectional area of the pulse collector at the selected location divided by its perimeter at that location.

The hydraulic diameter of the filter element opening (dfe in FIG. 13) is, likewise, determined in a plane that is transverse to the pulse axis 351. In particular, as used herein, the hydraulic diameter of the filter element opening (dfe) is determined at a location where the interior of filter media 347 of the filter element 340 is exposed to the interior volume 341 of the filter element 340 such that air can pass through the filter media 347 into and out of the interior volume 341 around a perimeter of the interior volume of the filter element 340. In example embodiments in which an end cap 380 is used, that location will be found at an interior edge 388 of the end cap 380. The hydraulic diameter of the filter element opening 345 is also calculated according to the equations described above, i.e., the hydraulic diameter of the filter element opening dfe is four times the cross-sectional area of the filter element opening at the selected location divided by its perimeter at that location. In the case of, e.g., pleated filter media, the cross-sectional are is defined by the locations of the inner edges of the folds making up the pleats in the filter media.

Although not depicted in the schematic diagram of FIG. 13, in example embodiments of the filter elements as described herein, an inner liner may be provided over the inner surface of the filter media 347 to offer e.g., protection, support, etc. to the filter media. Examples of some liners that may be used in connection with the filter elements described herein may be found in, e.g., U.S. Pat. No. 6,488,746 (Kosmider et al.), U.S. Pat. No. 8,128,724 (Mills et al.), etc. In such an arrangement, the hydraulic diameter of the filter element opening dfe is determined using the inner surface of the inner liner.

In example embodiments of the air filter systems described herein, the hydraulic diameter of the filter element opening (dfe) is 112% or less of the hydraulic diameter of the filter end opening of the pulse collector (dpc). In one or more alternative embodiments of the air filter systems described herein, the hydraulic diameter of the filter element opening (dfe) is 108% or less of the hydraulic diameter of the filter end opening of the pulse collector (dpc).

The hydraulic diameter of the filter element opening (dfe) may be 90% or more of the hydraulic diameter of the filter end opening of the pulse collector (dpc). In alternative embodiments of the air filter systems described herein, the hydraulic diameter of the filter element opening (dfe) is 95% or more of the hydraulic diameter of the filter end opening of the pulse collector (dpc).

In some embodiments, the absolute value of a difference between the hydraulic diameter of the filter element opening (dfe) and the hydraulic diameter of the filter end opening of the pulse collector (dpc) is within 2% or less of the hydraulic diameter of the filter element opening.

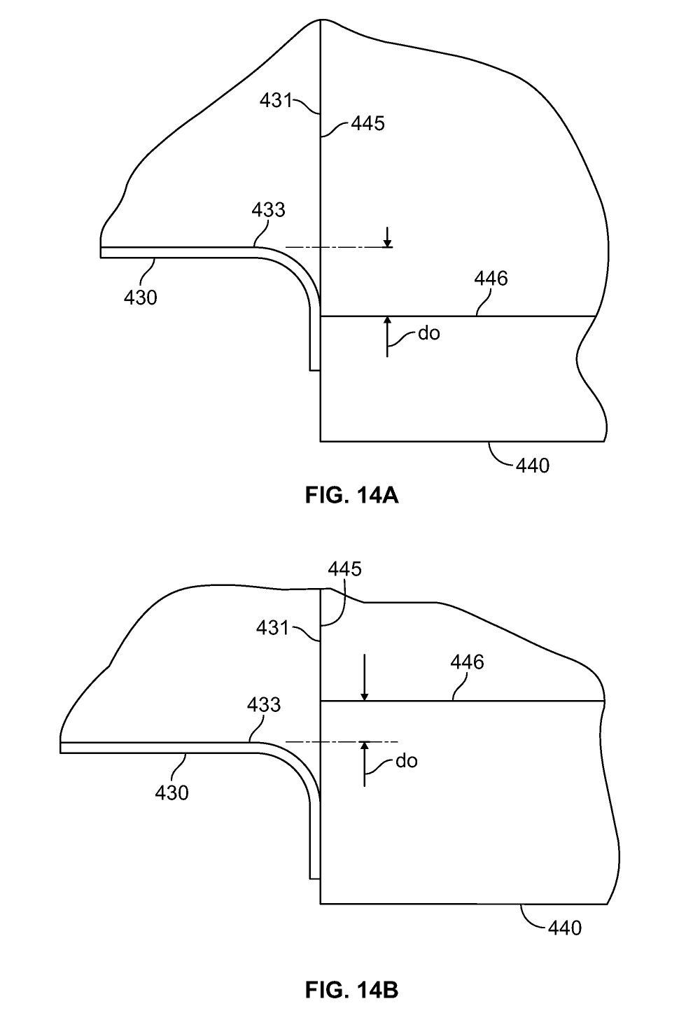

### 4. Example Advantageous Arrangements, FIGS. 14-17

Another manner in which the air filter systems described herein may be characterized can be described in connection with FIGS. 14A and 14B, which depict cross-sectional views of enlarged portions of the interface between the filter end opening 431 of a pulse collector 430 and a filter element 440. The filter element 440 defines an inner surface 446 while the pulse collector 430 defines an inner surface 433. In example embodiments, the inner surface 433 of the pulse collector 430 is in alignment with the inner surface 446 of the filter element 440 at the filter end opening 445 of the filter element 440. In example embodiments, that alignment may be measure at the locations used to determine the hydraulic diameters of the filter end opening of the pulse collector and the filter element (dpc and dfe as described above in connection with FIG. 13).

In some instances, however, there may be an offset between the inner surface 433 of the filter end opening 431 of the pulse collector 430 and the inner surface 446 of the filter element opening 445 of the filter element 440. In particular, that offset (do in FIGS. 14A and 14B) may result in an arrangement in which the inner surface 433 and 446 do not align with each other around the perimeter of the junction between the filter end opening 431 and the filter element opening 445. FIG. 14A depicts an example in which the inner surface 433 of the filter end opening 431 of the pulse collector 430 is located inwardly from the inner surface 446 of the filter element 440 at the filter end opening 445 at an offset distance (do) as seen in FIG. 14A. FIG. 14B depicts an example in which the inner surface 446 of the filter element 440 at the filter end opening 445 is located inwardly from the inner surface 433 of the filter end opening 431 of the pulse collector 430 at an offset distance (do) as seen in FIG. 14B.

In example embodiments, the offset (do) between the inner surface 446 of the filter element opening 445 and the inner surface 433 of the filter end opening 431 of the pulse collector 430 is no more than 15 millimeters at any location about a perimeter of the filter element opening 445. In one or more alternative embodiments, the offset (do) between the inner surface 446 of the filter element opening 445 and the inner surface 433 of the filter end opening 431 of the pulse collector 430 is no more than 10 millimeters at any location about a perimeter of the filter element opening 445. In one or more alternative embodiments, the offset (do) between the inner surface 446 of the filter element opening 445 and the inner surface 433 of the filter end opening 431 of the pulse collector 430 is no more than 5 millimeters at any location about a perimeter of the filter element opening 445.

The air filter systems described herein include, in example embodiments, a pulse collector located between the tube sheet and the filter element on the dirty air chamber side of the tube sheet. In example embodiments, the pulse collector may be in the form of a Venturi element including a throat that constricts the passageway through the pulse collector at a location between its ends as described in, e.g., one or more of the following: U.S. Pat. No. 3,942,962 (Duyckinck), U.S. Pat. No. 4,218,227 (Frey), U.S. Pat. No. 6,090,173 (Johnson et al.), U.S. Pat. No. 6,902,592 (Green et al.), U.S. Pat. No. 7,641,708 (Kosmider et al.), and US Patent Application Publication No. US2013/0305667 A1.

In one or more alternative embodiments, the pulse collectors used in the air filter systems described herein may be in the form of straight to this without any constriction or divergence between the tube sheet and the filter element. One example of such a pulse collector is depicted in, e.g., FIG. 11.

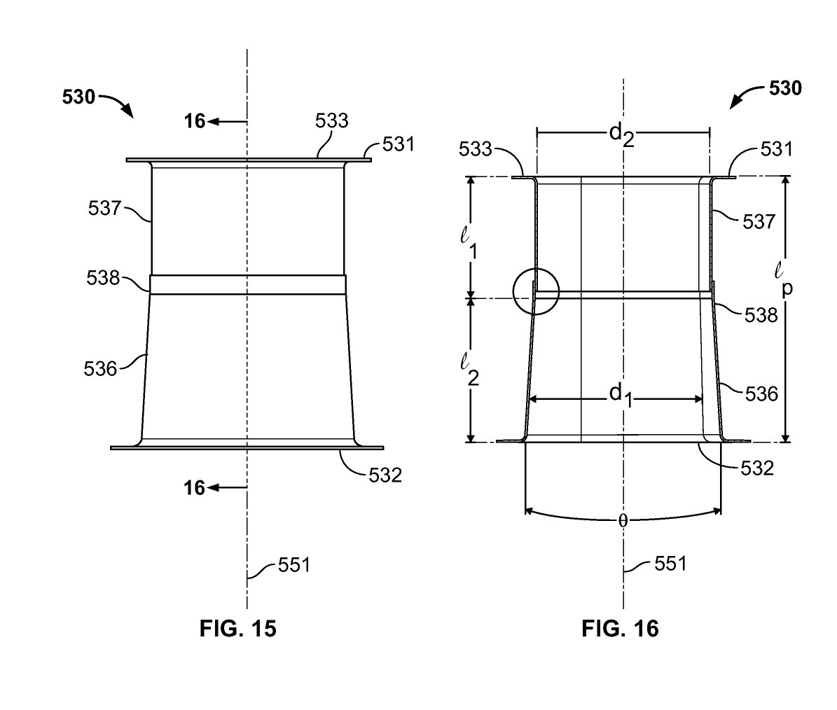

In still other embodiments, the pulse collectors used in the air filter systems described herein may include a pulse section and a filter section that meet at a junction located between the filter end and the tube sheet end of the pulse collector. One illustrative embodiment of such a pulse collector 530 is depicted in FIGS. 15-17. The pulse collector 530 includes a pulse section 536 and a filter section 537 that meet at a junction 538 at a location between the filter end 531 and the tube sheet end 532 of the pulse collector 530. As with the other embodiments of pulse collectors as described herein, the pulse axis 551 and extends through the pulse collector 530.

In example embodiments, the pulse collectors having both a pulse section and a filter section as described herein may have a pulse section 536 in which the portion of the passageway through the pulse collector 530 defined by the pulse section 536 has a hydraulic diameter (see, e.g., d1 in FIG. 16) that increases when moving from the junction 538 towards the tube sheet end 532 of the pulse collector 530. The hydraulic diameter of the pulse section 536 is determined according to the principles described herein, i.e., the hydraulic diameter of the pulse section 536 at any point along the pulse axis 551 is the product of four times the cross-sectional area of the pulse section 536 divided by the perimeter at that location.

In example embodiments, the pulse collectors having both a pulse section and a filter section as described herein may have a filter section 537 in which the portion of the passageway through the pulse collector 530 defined by the filter section 537 has a hydraulic diameter (see, e.g., d2 in FIG. 16) that remains constant when moving from the junction 538 towards the filter end 531 of the pulse collector 530. The hydraulic diameter of the filter section 537 is determined according to the principles described herein, i.e., the hydraulic diameter of the filter section 537 at any point along the pulse axis 551 is the product of four times the cross-sectional area of the filter section 537 divided by the perimeter at that location. It should be understood that the filter section 537 may have a hydraulic diameter that increases slightly at the filter and 531 due to manufacturing limits in the forming of the materials used to manufacture the filter section 537. The hydraulic diameter of the filter section 537 may, however, be constant over substantially its entire length with the exception of that small transition area which may constitute less than 10% of the overall length of the filter section 537.

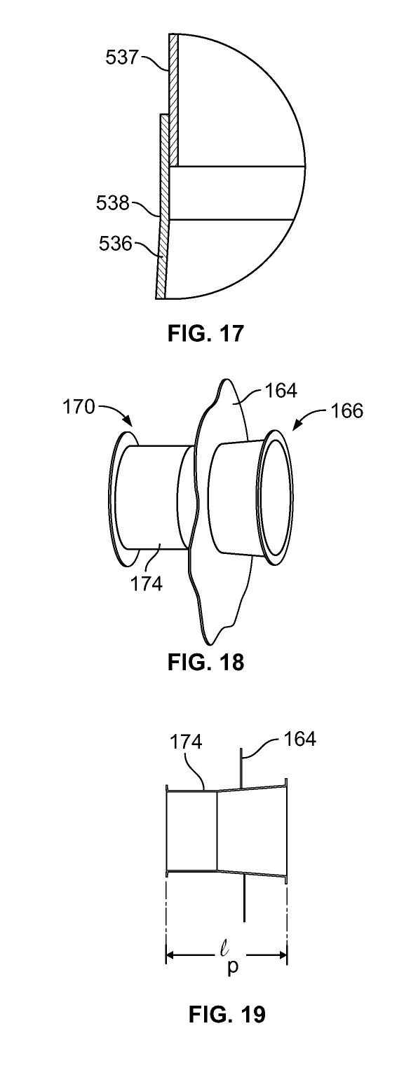

In some examples that include a pulse section 536 and a filter section 537, the pulse section 536 and the filter section 537 may be in the form of separate articles attached to each other at the junction 538. The pulse section 536 and the filter section 537 may overlap each other within or near the junction 538 as seen in, e.g., the enlarged cross-sectional view of FIG. 17. It should be noted that the precise location of the junction 538 is, in the illustrative embodiment depicted in FIGS. 15-17, selected as the location at which the pulse collector 530 begins to diverge such that the hydraulic diameter increases when moving towards the tube sheet end 532.

The connection made near the junction 538 of the pulse collector 530 may be constructed using a variety of techniques and/or components. For example, the pulse section 536 and filter section 537 may be connected to each other using adhesives, clamps, mechanical fasteners, etc. In example embodiments, the pulse section 536 and the filter section 537 may be welded together.

In example embodiments of the pulse collectors described herein, the pulse collector 530 may be described as having a passageway length (see, e.g., lp in FIG. 16) measured along the pulse axis 551 that is equal to or greater than a hydraulic diameter of the filter end opening 533 at the filter end 531 of the pulse collector 530. Further, in example embodiments of the pulse collectors described herein, the pulse collector 530 may be described as having a passageway length measured along the pulse axis 551 that is no more than three times the hydraulic diameter of the filter end opening 533 at the filter end 531 of the pulse collector 530. These relationships between the passageway length and the hydraulic diameter of the filter end opening 533 at the filter end 531 of the pulse collector 530 apply regardless of whether or not the pulse collector has the specific construction of pulse collector 530. In other words, the relationship between the passageway length and the hydraulic diameter at the filter end opening of a pulse collector used in air filter systems described herein may, in example embodiments, be applied to any pulse collector including those that include a throat and/or those that have a constant hydraulic diameter along their entire length (e.g., are in the form of a simple straight wall tube).

In example embodiments of the pulse collectors described herein that include a pulse section 536 and a filter section 537, the filter section 537 may have a filter section length (see, e.g., l₁ in FIG. 16) measured along the pulse axis 551 from the filter end 531 to the junction 538 and the pulse section 536 has a pulse section length (see, e.g., l₂ in FIG. 16) measured along the pulse axis 551 from the tube sheet end 532 to the junction 538. In example embodiments of the pulse collectors described herein, the filter section length (l₁) is less than or equal to the pulse section length (l₂).

In some examples that include a pulse section 536 and a filter section 537, the filter section length (l₁) and the pulse section length (l₂) may have one or more selected relationships with the hydraulic diameter of the filter end opening 533 (d2) at the filter end 531 of the pulse collector 530. For example, the filter section length (l₁) and the pulse section length (l₂) can be both equal to or less than 1.5 times the hydraulic diameter of the filter end opening 533 (d2) at the filter end 531 of the pulse collector 530. In some examples, the filter section length (l₁) and the pulse section length (l₂) are both equal to or less than the hydraulic diameter of the filter end opening 533 (d2) at the filter end 531 of the pulse collector 530.

As discussed in connection with the pulse section 536 of the pulse collector 530, in example embodiments of pulse collectors that may be used in air filter systems as described herein, the pulse section 536 may have a hydraulic diameter (d1) that increases when moving from the junction 538 to the tube sheet end 532 of the pulse collector 530. In example embodiments, that increasing hydraulic diameter is a function of an included angle formed by the opposing walls defining the portion of the passageway in the pulse section 536, with the opposing walls diverging from the pulse axis 551 at an included angle (see, e.g., angle θ (theta) in FIG. 16).

In some example embodiments, the included angle may be described as being greater than 0° and less than or equal to 10°. In one or more alternative embodiments, that included angle may be described as being greater than 3° or, in one or more alternative embodiments, greater than 5°. In example embodiments in which the included angle is less than or equal to 8°, and in still other embodiments, the included angle may be described as being less than or equal to 7°. Any combination of these upper and lower limits for the included angle may be used to characterize the divergence of opposing walls of a pulse section of a pulse collector as described herein.

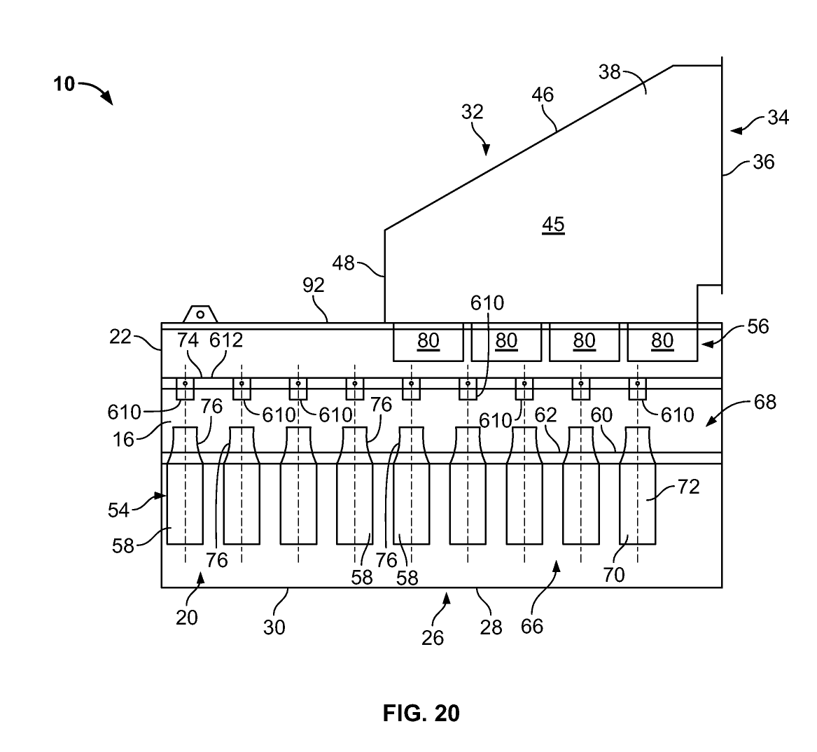

### D. Example Advantageous Arrangements, FIGS. 20-27

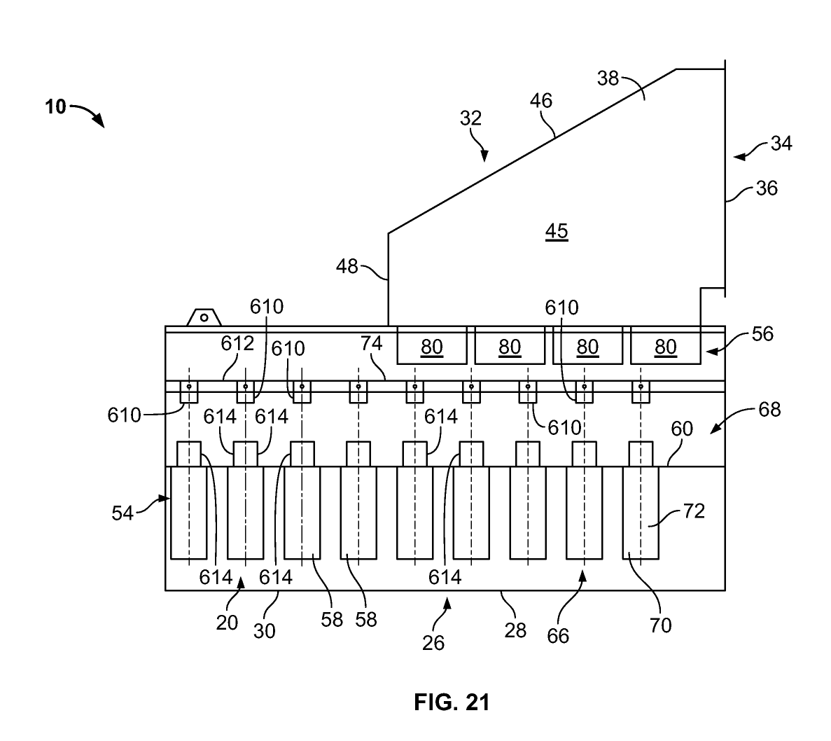

Variations on the system 10 are illustrated in FIGS. 20-27. It should be understood that each of the systems of FIGS. 20-27 are analogous to the system 10 of FIGS. 1-5, and the same reference numerals are used for analogous parts. Description of the numbered parts is incorporated herein by reference from the above description of FIGS. 1-5. The descriptions below will discuss the differences between the systems of FIGS. 21-27 and the system 10 shown on FIGS. 1-5.

In FIG. 20, the system 10 is shown as including pipe extensions 610, extending perpendicularly from the main blow pipe 612. The pipe extensions 610 direct pulses of air toward the Venturi members 76. The pipe extensions 610 are provided to improve the pulse distribution from the blow pipe 612. The blow pipe 612, without pipe extensions 610, distribute fluid (e.g., air) pulses through holes drilled or punched along the length of the blow pipe 612. These simple holes direct the air pulse, but the pulse tends to continue mostly in the direction of flow contained in the main blow pipe 612. To address this problem and improve the pulse energy delivered to each filter element 58, the pipe extensions 610 provide a sufficient length of pipe that allows for the air to fill it and then exit in a direction generally parallel to its length. The pipe extensions 610 aid in the pulse flow completing a 90 degree turn, filling the pipe extension 610, and then exiting the pipe extension 610 straight towards the center of the target filter opening. Advantages are achieved when the length of the pipe 610 is about ten times the inner diameter of the pipe extension 610, but advantages can also be achieved by having the length of the pipe extension 610 be within the range of about 2-5 times the inner diameter of the pipe extension 610.

FIG. 21 shows system 10 with pipe extensions 610 protruding perpendicularly from the blow pipe 612, as is illustrated in FIG. 20. In the embodiment of FIG. 21, instead of Venturi members 76, there is a plurality of straight pulse collectors 614 located in the filtered air volume 68 on the clean air side of the tube sheet 60.

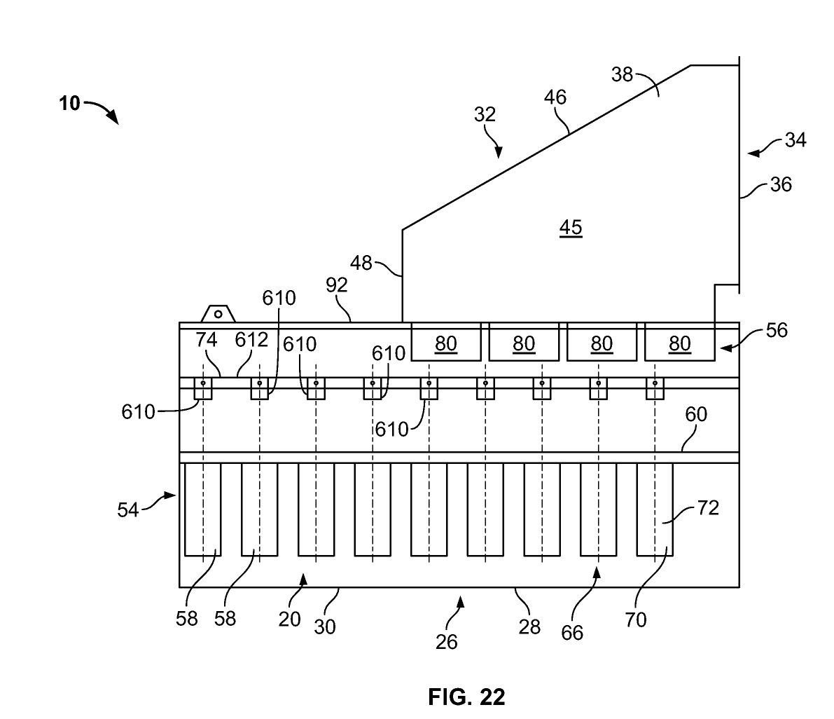

In FIG. 22, the system 10 is illustrated as being Venturi member-free and pulse collector-free. In FIG. 22, pipe extensions 610 are shown protruding perpendicular from the blow pipe 612. The pipe extensions 610 pulse directly to the filter elements 58 and without any intervening Venturi member or pulse collector to help collect or direct the pulse.

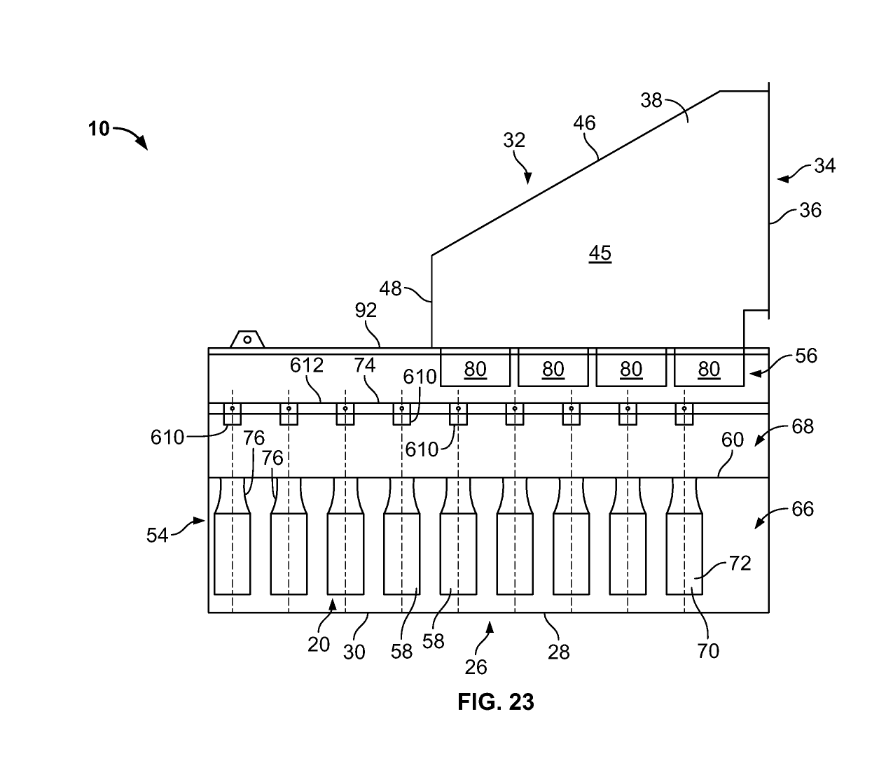

The system of FIG. 23 shows Venturi members 76 in the unfiltered air volume 66 on the dirty air side of the tube sheet 60. FIG. 23 also illustrates using pipe extensions 610 extending perpendicularly from the blow pipe 612.

A variation on the system 10 of FIG. 23 is shown in FIG. 24, in which instead of Venturi members 76 being in the unfiltered air volume 66, there are straight pulse collectors 614 located in the unfiltered air volume 66. The filtered air volume 68 of each of FIGS. 22-27 is free of pulse collectors in the filtered air volume 68 downstream of the tube sheet 60.

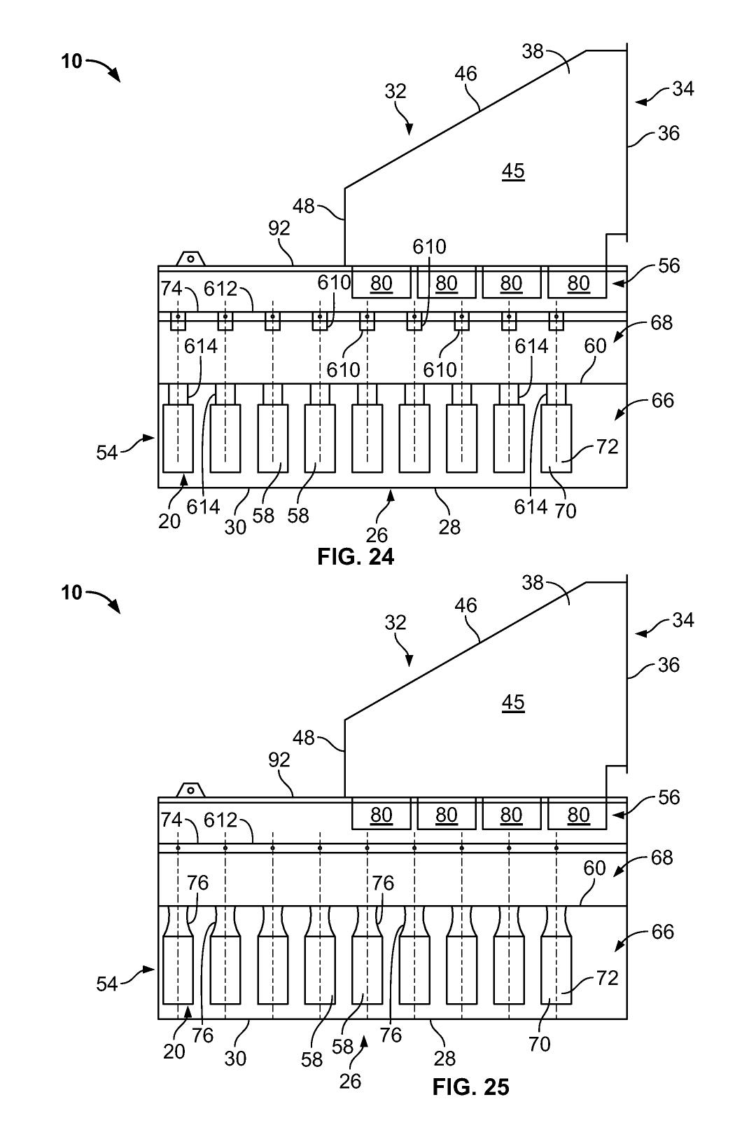

FIG. 25 shows another variation of the FIG. 23 embodiment, in which there are no pipe extensions 610 for pulsing. Rather, the pulsing comes directly out of the blow pipe 612 through blow pipe holes. As with the embodiment of FIG. 23, there are Venturi members 76 in the unfiltered air volume 66 on the upstream side of the tube sheet 60.

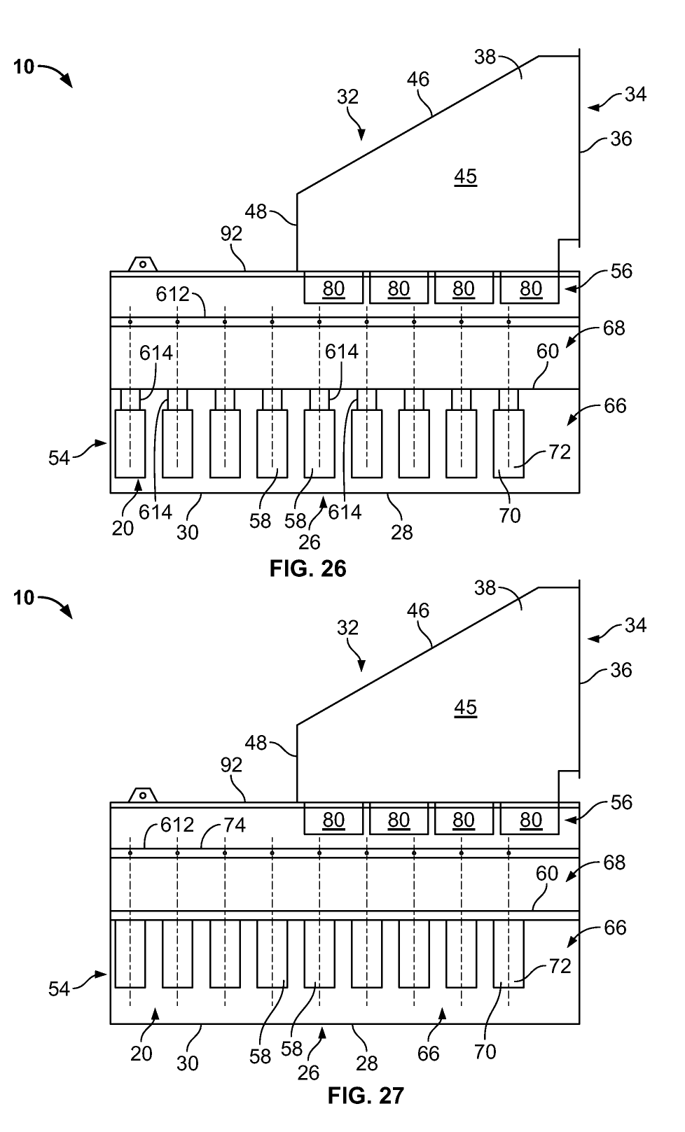

FIG. 26 is a variation of FIG. 25, in that it is free of pipe extensions 610 and includes only blow pipe 612 for emitting air pulses. In the FIG. 26 embodiment, instead of Venturi elements 76 in the unfiltered air volume 66, there are straight pulse collectors 614 upstream of the tube sheet 60 and located between the tube sheet 60 and the filter elements 58.

FIG. 27 is a variation of FIG. 22. In FIG. 27, the system 10 is free of pipe extensions 610 and includes only a blow pipe 612 with apertures for emitting pulses. In the system 10 of FIG. 27, there are no Venturi elements or pulse collectors anywhere in the system, either upstream or downstream of the tube sheet 60.

### E. Example Methods

To service any of the systems described above, the elements in the first stage 54 are accessed through the inlet arrangement 26, and the elements in the second stage 56 are accessed through a hatch or access panel in the housing 16. After a period of operation, it will become necessary to remove the elements in each stage and replace them with new elements. Not all stages will necessarily need servicing at the same time. The stages downstream of the most upstream stages may need servicing less frequently than the most upstream stage. During servicing, the elements are removed and replaced with new filter elements.

The systems described above can be used in methods of filtering. Methods of filtering air for a gas turbine system can include directing air to be filtered in through an inlet flow face 28 of an inlet arrangement 26 of a housing 16 having an interior 20. Air is then directed through at least first and second stages 54, 56 of filter element arrangements held within the interior 20 of the housing 16. The first and second stages 54, 56 of filter element arrangements are operably sealed within the housing 16 such that air flowing through the inlet arrangement 26 must pass through the first and second stages 54, 56 of filter element arrangements. Air is then directed through an outlet hood 32 having an outlet arrangement 34 defining an outlet flow face 36. The outlet flow face 36 is angled 45-135° relative to the inlet flow face 28. The outlet hood 32 is free of the first and second stages 54, 56 of filter element arrangements.

In the method of filtering, the step of directing the air through at least first and second stages 54, 56 of filter element arrangements includes directing the air through a plurality of further stages 103 of filter element arrangements operably sealed within the housing 16, each of the stages being one of upstream or downstream of the other stages in the housing.

The method of filtering may also include periodically directing a jet pulse of fluid from a downstream side to an upstream side of the first stage filter element arrangements 54.

In some implementations, the step of periodically directing a jet pulse of fluid can include directing the jet pulse of fluid through a plurality of pulse collectors 174 positioned in an unfiltered air volume 66 of the housing 16 and then directing the jet pulse to the first stage filter element arrangements 54.

The step of directing the jet pulse of fluid through a plurality of pulse collectors 174 can include, in some embodiments, directing the jet pulse of fluid through a filtered air volume 68 of the housing 16 that is free of pulse collectors 174.

Some embodiments of the method may include the step of periodically directing a jet pulse of fluid as directing the jet pulse of fluid through a plurality of pipe extensions 610 protruding from a blowpipe 612.

The above specification, examples and data provide a complete description of principles. Many embodiments can be made applying these principles.

1-44. (canceled)

45. An air intake filter system for a gas turbine inlet; the air intake filter system comprising:
(a) a housing having an interior, an inlet arrangement defining an inlet flow face for taking in unfiltered air, and an outlet hood having an outlet arrangement defining an outlet flow face for exiting filtered air;
(i) the inlet flow face and the outlet flow face being angled 45-135° relative to each other;
(b) at least first and second stages of filter element arrangements held within the interior of the housing; the first and second stages of filter element arrangements being operably sealed within the housing such that air flowing through the inlet arrangement must pass through the first and second stages of filter element arrangements before exiting through the outlet arrangement;
(c) the outlet hood being free of the first and second stages of filter element arrangements;
(d) a pulse jet system oriented within the housing interior and disposed to periodically send a blast of fluid to the first stage filter element arrangement;
(e) a tubesheet arranged in the housing interior, the tubesheet dividing the interior between an unfiltered air volume and a filtered air volume; the tubesheet having a plurality of apertures, the tubesheet having a dirty air side in the unfiltered air volume and an opposite clean air side in the clean air volume;
(f) a plurality of pulse collectors mounted in communication with the apertures in the tubesheet in the unfiltered air volume; and
(g) wherein the first stage filter element arrangement is mounted in communication with the pulse collectors in the unfiltered air volume, the pulse collectors being axially between the first stage filter elements and the tubesheet.

46. The air intake filter system of claim 45 wherein:
(a) the at least first and second stages of filter element arrangements include at least a third stage of filter element arrangement operably sealed within the housing.

47. The air intake filter system of claim 45 wherein:
(a) the at least first and second stages of filter element arrangements includes a plurality of further stages of filter element arrangements operably sealed within the housing, each of the stages being one of upstream or downstream of the other stages in the housing.

48. The air intake filter system of claim 45 wherein:
(a) one of the at least first and second stages of filter element arrangements includes a pre-filter arrangement at or adjacent to the inlet arrangement.

49. The air intake filter system of claim 45 wherein:
(a) the second stage of filter element arrangements includes a plurality of elements operably held by a second tubesheet in the interior of the housing; the second tubesheet being downstream of the first tubesheet.

50. The air intake filter system of claim 49 wherein:
(a) the first tubesheet is +/−30° of being parallel to the inlet flow face; and
(b) the second tubesheet is spaced from the first tubesheet and is +/−30° of being parallel to the first tubesheet.

51. The air intake filter system of claim 45 wherein:
(a) the second stage filter element arrangement is oriented vertically above the first stage filter element arrangement.

52. The air intake filter system of claim 45 wherein:
(a) the housing includes a base structure holding the first stage filter element arrangement spaced vertically above a base surface; and
(b) the inlet flow face is between the base surface and the first stage filter element arrangement.

53. The air intake filter system of claim 45 wherein:
(a) the pulse collectors are Venturi members.

54. The air intake filter system of claim 45 wherein:
(a) the pulse collectors are non-porous tubes.

55. The air intake filter system of claim 45 wherein:
(a) the clean air side of the tubesheet is pulse collector-free.

56. The air intake filter system of claim 45 wherein:
(a) the pulse jet system includes a blowpipe having pipe extensions to direct the blast of fluid to the first stage filter element arrangement.

57. The air intake filter system of claim 45 wherein:
(a) the pulse jet system includes a blowpipe with holes that is pipe-extension-free to direct the blast of fluid to the first stage filter element arrangement.

58. The air intake filter system of claim 45 wherein:
(a) the second stage filter element arrangement includes a plurality of filter elements having non-cylindrical and non-panel-shaped media packs.

59. The air intake filter system of claim 45 wherein:
(a) the second stage filter element arrangement includes a plurality of filter elements having pleated media and having a wave-shaped cross-section.

60. A method of filtering air for a gas turbine system; the method comprising:
(a) directing air to be filtered in through an inlet flow face of an inlet arrangement of a housing having an interior,
(b) then directing the air through at least first and second stages of filter element arrangements held within the interior of the housing; the first and second stages of filter element arrangements being operably sealed within the housing such that air flowing through the inlet arrangement must pass through the first and second stages of filter element arrangements;
(c) then directing the air through an outlet hood having an outlet arrangement defining an outlet flow face;
(i) the outlet flow face being angled 45-135° relative to the inlet flow face;
(ii) the outlet hood being free of the first and second stages of filter element arrangements; and
(d) periodically directing a jet pulse of fluid from a downstream side to an upstream side of the first stage filter element arrangements, including directing the jet pulse of fluid through a plurality of pulse collectors positioned in an unfiltered air volume of the housing and then directing the jet pulse to the first stage filter element arrangements.

61. The method of claim 60 wherein:
(a) the step of directing the jet pulse of fluid through a plurality of pulse collectors includes directing the jet pulse of fluid through a filtered air volume of the housing that is free of pulse collectors.

62. A gas turbine air intake system comprising:
(a) a housing having an inlet arrangement, an outlet hood for exhausting filtered air, and an internal volume;
(b) a tubesheet arranged in the housing volume, the tubesheet dividing the volume between an unfiltered air volume and a filtered air volume; the tubesheet having a plurality of apertures;
(c) a plurality of pulse collectors mounted in communication with the apertures in the tubesheet in the unfiltered air volume;
(d) a plurality of filter elements mounted in communication with the pulse collectors in the unfiltered air volume, the pulse collectors being axially between the elements and the tubesheet;
(e) a pulse generator arranged to periodically emit gas pulses from the filtered air volume, through the tubesheet apertures, through the pulse collectors, and into the filter elements; and
(f) wherein the tubesheet has a dirty air side in the unfiltered air volume and an opposite clean air side in the clean air volume;
(i) the clean air side of the tubesheet being pulse-collector free.

63. A gas turbine air intake system according to claim 62 wherein:
(a) the pulse collectors have a passageway that extends through the pulse collector from a filter end opening at a filter end of the pulse collector element to a tubesheet opening at a tubesheet end of the pulse collector;
(b) the pulse generator is configured to deliver the pulses of air along a pulse axis that extends from the pulse generator through the aperture in the tubesheet, the tube sheet opening in the pulse collector, and the filter end opening in the pulse collector, wherein the pulse generator comprises a pulse outlet located on the pulse axis and through which the pulses of air are delivered along the pulse axis, the pulse outlet defined by opposing walls that do not diverge with respect to the pulse axis, and wherein the pulse outlet defines a pulse outlet hydraulic diameter; and
a pulse distance measured along the pulse axis from the pulse outlet to the filter element opening is 30 or more times the pulse outlet hydraulic diameter.

64. A method of retrofitting a gas turbine air intake system, the system having
a housing having a dirty air inlet, a filtered air outlet, and an internal volume; a tubesheet arranged in the housing volume, the tubesheet dividing the volume between a unfiltered air volume and a filtered air volume; the tubesheet having a plurality of apertures; and a plurality of pulse collectors mounted in communication with the apertures in the tubesheet in the filtered air volume; the method comprising:
(a) removing the pulse collectors from the tubesheet;
(b) mounting a plurality of pulse collectors in the unfiltered air volume in communication with the apertures in the tubesheet; and
(c) mounting a plurality of filter elements in the unfiltered air volume in communication with the pulse collectors such that the pulse collectors are axially between the filter elements and the tubesheet.
